(19) United States
(12) Patent Application Publication
(10) Pub. No.: US 2014/0279610 A1
(43) Pub. Date: Sep. 18, 2014

(54) AUTOMATED METHOD AND SYSTEM FOR ESTABLISHING AND ASSURING SERVICE CONTRACT ACT COMPLIANCE WITH HEALTH & WELFARE FRINGE BENEFITS

(71) Applicant: Angela Hendrix, San Antonio, TX (US)

(72) Inventor: Angela Hendrix, San Antonio, TX (US)

(21) Appl. No.: 14/216,428

(22) Filed: Mar. 17, 2014

Related U.S. Application Data
(60) Provisional application No. 61/787,655, filed on Mar. 15, 2013.

(51) Int. Cl. G06Q 30/00; G06Q 10/10

(52) U.S. Cl. CPC G06Q 30/018; G06Q 10/1057
USPC 705/317

(57) ABSTRACT

The disclosure provides a method for establishing and assuring fringe benefit compliance for contracts subject to government acts and agreements. Client data is received by a computing system with a link to a database. The information is subsequently stored in the database. The computing system may provide a report including the client data.

The data may then be manipulated by one of the following services: an employee fringe benefits management information system program service, a trust/escrow account service, a consulting service, and a retroactive auditing service. Analyses are created relative to the services rendered to the client data. Analyses are then periodically compared with refined parameters to stay within the boundaries of industry legalities.

The disclosure further provides a system and computer program product for establishing and assuring fringe benefit compliance for contracts subject to government acts and agreements. The computing system may utilize connections to electronic devices, databases, etc.

### CROSS-REFERENCE TO RELATED APPLICATIONS

This applications claims priority to U.S. Provisional Patent Application Ser. No. 61/787,655, filed Mar. 15, 2013, which is hereby incorporated by reference in its entirety.

### FIELD OF THE INVENTION

The present disclosure relates to an automated method and system for establishing and assuring fringe benefit compliance for contracts subject to Davis-Bacon Act, Davis-Bacon Related Acts, Service Contract Act, and Collective Bargaining Agreements.

### BACKGROUND OF THE INVENTION

Compliance with fringe benefit regulations has been an issue for many government contractors and commercial entities.

The Davis-Bacon Act (DBA) of 1931 requires contractors working on federally-funded construction projects to pay employees a “prevailing wage”, including the “anticipated cost of prevailing benefits”. This is generally expressed as a per-hour wage and per-hour cash equivalent of benefits and is often based on a union scale. Prevailing wages are set by the U.S. Department of Labor and are included in the bid specifications of covered contracts. Under the DBA, employers can either choose to pay the fringe benefits as additional cash wages or provide a “bona fide” benefit plan. Benefits that might be included in such a plan are retirement accounts (401 plans or pensions), medical insurance, vision insurance, dental insurance, disability and sickness insurance, accident or sickness insurance, unemployment insurance, life insurance, sick leave, bereavement leave, vacation leave, holiday pay, other types of paid leave and cost of apprenticeship or other similar programs.

Other acts and agreements such as Davis-Bacon Related Acts, McNamara-O'Hara Service Contract Act of 1965, and Collective Bargaining Agreements require policies similar to that of the Davis-Bacon Act of 1931.

For example, Davis-Bacon prevailing wage requirements have been extended to Davis-Bacon Related Acts (DBRA) that provide federal assistance for construction projects through grants, loans, loan guarantees and insurance. Many, but not all, of the related Acts are identified in 29 C.F.R. §5.1(a).

The Service Contract Act (SCA) of 1965 applies to service contracts and sets parameters pertinent to the applicable U.S. Department of Labor wage determination. Requirements include, but are not limited to, minimum wage hourly rate, minimum annual vested vacation, minimum annual holidays, and minimum health and welfare fringe benefit hourly rate. Under the SCA, employers can either choose to pay any of the minimum fringe benefit requirements—vacation, holiday and/or health and welfare—at an hourly equivalent “cash in-lieu-of” rate separate and apart from the minimum hourly wage rate or provide the actual fringe benefit in the form of paid vacation leave, paid holiday leave, and health and welfare through one or more “bona fide” company-sponsored benefit program/plan(s). Benefits that might be included in such a program/plan are retirement accounts (401 plans or pensions), medical insurance, vision insurance, dental insurance, disability insurance, accident or sickness insurance, unemployment insurance, life insurance, sick leave, bereavement leave, vacation leave (in excess of the minimum annual requirement), holiday pay (in excess of the minimum annual requirement), and other types of paid leave.

Collective Bargaining Agreements (CBA), when incorporated into a contract reflects the wage determination for that contract. The CBA will set forth the minimum wages and minimum “bona fide” fringe benefits an employer must provide the employees. Benefits that might be included in a CBA include retirement accounts (401 plans or pensions), medical insurance, vision insurance, dental insurance, disability and sickness insurance, accident insurance, unemployment insurance, life insurance, sick leave, bereavement leave, vacation leave, holiday pay, and other types of paid leave. The CBA will identify how the benefits must be paid, as “cash in-lieu-of”, “bona fide” fringe benefit program/plan, and/or a combination of both. If incorporated, a CBA's requirements are applicable to both government and commercial contracts.

The present system's application consists of a process for tracking prevailing wage compliance with the added benefit of mathematical consolidation and precision through parameters provided by emerging software. Accordingly, this disclosure is able to deliver novel choices in a highly consumer friendly, proprietary way.

### BRIEF SUMMARY OF THE INVENTION

The present system integrates data through the development of a database or set of databases that previously could only rely mostly on the business intellect of highly experienced professionals. Instead of the prior cumbersome and expensive processes, the present process and system provide the ability to take and translate industry specific business, regulatory and legal nuances into highly refined parameters that keep a user compliant with government contracting requirements and allow them to handle their accounts with precision, efficiency and effectiveness.

The disclosure at hand provides a method for establishing and assuring fringe benefit compliance for contracts subject to Davis-Bacon Act, Davis-Bacon Related Acts, Service Contract Act, and Collective Bargaining Agreements (whether incorporated in government or commercial contract(s)). The method includes receiving pertinent client information by a computing system, wherein the computing system comprises a link to a database where the client information is stored. A fringe benefit programs/management information system (MIS) service is provided based on the client information. The fringe benefit programs/management information system (MIS) service includes fringe benefit programs/plans and a fringe benefit provider/program data management service. A trust and/or escrow account service is provided based on the client information. The trust and/or escrow account service comprises a shortfall management service, an employer benefit credit management service, and an account management service for employees on behalf of an employer. A consulting service based on client information is provided. The consulting service includes contract management services including but not limited to pricing strategies, contracts administration, budget forecasting, prevailing wage conformances, price adjustment processes, and methodology to follow for state or U.S. Department of Labor (DoL) compliance up to and including formal agency audit.

Education services for the clients is provided either online or in-person. The education services are pertinent to the compliance of Department of Labor standards.

The method further includes an auditing service based on the client information is retroactively provided. Analyses relative to oversight of the client information is provided. Periodical comparison of analyses of the client information with refined parameters based on industry legalities is further included.

The system includes a fringe benefit management information system service (MIS) including a memory, a database, a display and a processor. The database comprises a census populated by client information. The processor is operably connected with the memory and the display and is configured to provide a trust and/or escrow account service based on the client information. The trust and/or escrow account service includes shortfall management, employer benefit credit management, and account management for employees on behalf of employers. The processor is configured to provide an employee benefits management information system (MIS) service based on client information, wherein the employee benefits management information system (MIS) service includes fringe benefit provider/program data management and trust/escrow account management. The processor is further configured to provide a consulting service based on client information, wherein the consulting services includes contracts management services for clients. The processor is further configured to provide an education service for the clients, wherein the education service includes online modules. The processor is further configured to retroactively provide an auditing service based on the client information, provide analyses relative to oversight of client information, and periodically compare analyses of the client information with refined parameters based on industry legalities.

Accordingly, it is one object of the current disclosure to efficiently establish and assure fringe benefit compliance for contracts subject to Davis-Bacon Act, Davis-Bacon Related Acts, Service Contract Act, and Collective Bargaining Agreements (whether incorporated in government or commercial contract(s)). Another object of the current disclosure is to provide precision handling of a client's information.

These and other aspects of the disclosed subject matter, as well as additional novel features, will be apparent from the description provided herein. Provided, however, any particular embodiment need not contain all of the aspects and an aspect or aspects, in any possible combination, from one embodiment may be implemented in another embodiment and remain within the scope of this disclosure. Furthermore, any particular aspect may be removed from one or more embodiments and remain within the scope of this disclosure. The intent of this summary is not to be a comprehensive description of the subject matter, but rather to provide a short overview of some of the subject matter's functionality. Other systems, methods, features and advantages here provided will become apparent to one with skill in the art, who has the benefit of this invention's teachings, upon examination of the following FIGURES and detailed description. It is intended that all such additional systems, methods, features and advantages that are included within this description, be within the scope of any claims herein or filed later.

### BRIEF DESCRIPTION OF THE DRAWINGS

Novel and nonobvious features believed characteristic of the disclosed subject matter will be set forth in claims that follow. The disclosed subject matter itself, however, as well as certain particular modes of use, further objectives, and advantages thereof, will be understood by reference to the following detailed description of illustrative embodiments when read in conjunction with the accompanying drawings, wherein:

FIG. 1 depicts a computer system and related peripherals that may operate with the establishing and assuring compliance with fringe benefits for contracts subject to Davis-Bacon Act, Davis-Bacon Related Acts, Service Contract Act, and Collective Bargaining Agreements (whether incorporated in government or commercial contract(s)) in accordance with one embodiment.

FIG. 2 depicts a flow chart depicting the method of establishing and assuring compliance with fringe benefits for contracts subject to Davis-Bacon Act, Davis-Bacon Related Acts, Service Contract Act, and Collective Bargaining Agreements (whether incorporated in government or commercial contract(s)) in accordance with one embodiment.

FIG. 3A depicts a screen image of fringe benefit compliance report in accordance with one embodiment.

FIG. 3B depicts a screen image of a chart depicting “cash in lieu of” fringe benefits in accordance with one embodiment.

FIG. 4 depicts a screen image of a chart depicting sick leave paid in accordance with one embodiment.

FIG. 5 depicts a screen image of a chart depicting medical fringe benefits in accordance with one embodiment.

FIG. 6 depicts a screen image of chart depicting total benefits credit toward fringe benefit requirement in accordance with one embodiment.

FIG. 7 depicts a screen image of a chart depicting a quarterly fringe benefit report with both averaging and individual calculation methods in accordance with one embodiment.

FIG. 7 depicts a screen image of a chart depicting a quarterly trust/escrow account report in accordance with one embodiment.

FIG. 8 depicts a screen image of a chart depicting a quarterly fringe benefit report with quarterly shortfall for averaging calculation method in accordance with one embodiment.

FIG. 9 depicts a screen image of a chart depicting an annual fringe benefit report with delta calculations in accordance with one embodiment.

FIG. 10 depicts a flowchart depicting the steps taken for the handling and manipulation of client data in accordance with one embodiment.

FIG. 11A depicts a first section of a flowchart depicting the interrelation of code representative of pertinent client data.

FIG. 11B depicts a second section of a flowchart depicting the interrelation of code representative of pertinent client data.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

One benefit of some embodiments of the disclosure is that information associated with compliance of the mentioned government acts may be collected from a wide variety of information sources, checked to make sure the information is not redundant, and stored in a database. Because of this, clients such as government contractors and commercial entities may benefit from specific analyses the computing system 100 may perform that may inform the government contractors and commercial entities of compliance with government acts concerning employees and/or transactions.

The information pertinent to the following statutes may be programmed into the computing system 100 found in FIG. 1. This information may serve as manipulation tools and parameters when analyzing client information for a specific task to be carried out such as, but not limited to a fringe benefits administration report. When client information is input into the computing system 100, the information may be manipulated by calculations and other information pertinent in the statutes. The statutes may help a client understand the past, current, and future statuses of employees' fringe benefit compliance.

The computing system 100 may contain computer readable program code in the form of the following statutes that may execute instructions for automating the steps for performing a method for establishing and assuring fringe benefit compliance for contracts subject to Davis-Bacon Act, Davis-Bacon Related Acts, Service Contract Act, and Collective Bargaining Agreements, including the producing of generated reports relating to analysis of client information in relation to fringe benefit compliance. The computing system 100 significantly improves the ability to contract with federal entities.

Using the results of the disclosed system 100, criminal actions and penalties may be avoided. This benefits government contractors, commercial entities, and the government by saving time on all parties parts as well as money.

The following exemplary statutes detail steps and guidelines that the system 100 may use in order to carry out the transformation of inputs into tangible outputs. Other embodiments of the present disclosure may perform steps, calculations, transformations of other statutes.

By way of an example, a system 100 of the present disclosure may be configured to act in relation to statute 29 C.F.R. §5.5, which concerns general requirements for employers to meet prevailing wage requirements for contracts subject to Davis-Bacon Act, Davis-Bacon Related Acts, and/or Collective Bargaining Agreements.

I. General Provisions and Minimum Prevailing Rates.

The Agency head shall cause or require the contracting officer to insert in full in any contract in excess of $2,000 which is entered into for the actual construction, alteration and/or repair, including painting and decorating, of a public building or public work, or building or work financed in whole or in part from Federal funds or in accordance with guarantees of a Federal agency or financed from funds obtained by pledge of any contract of a Federal agency to make a loan, grant or annual contribution (except where a different meaning is expressly indicated), and which is subject to the labor standards provisions of any of the acts listed in §5.1, the following clauses (or any modifications thereof to meet the particular needs of the agency, Provided, That such modifications are first approved by the Department of Labor):

Minimum Wages.

All laborers and mechanics employed or working upon the site of the work (or under the United States Housing Act of 1937 or under the Housing Act of 1949 in the construction or development of the project), will be paid unconditionally and not less often than once a week, and without subsequent deduction or rebate on any account (except such payroll deductions as are permitted by regulations issued by the Secretary of Labor under the Copeland Act (29 CFR part 3)), the full amount of wages and bona fide fringe benefits (or cash equivalents thereof) due at time of payment computed at rates not less than those contained in the wage determination of the Secretary of Labor which is attached hereto and made a part hereof, regardless of any contractual relationship which may be alleged to exist between the contractor and such laborers and mechanics.

Contributions made or costs reasonably anticipated for bona fide fringe benefits under section 1(b)(2) of the Davis-Bacon Act on behalf of laborers or mechanics are considered wages paid to such laborers or mechanics, subject to the provisions of paragraph (a)(1)(iv) of this section; also, regular contributions made or costs incurred for more than a weekly period (but not less often than quarterly) under plans, funds, or programs which cover the particular weekly period, are deemed to be constructively made or incurred during such weekly period. Such laborers and mechanics shall be paid the appropriate wage rate and fringe benefits on the wage determination for the classification of work actually performed, without regard to skill, except as provided in §5.5(a)(4). Laborers or mechanics performing work in more than one classification may be compensated at the rate specified for each classification for the time actually worked therein: Provided, That the employer's payroll records accurately set forth the time spent in each classification in which work is performed. The wage determination (including any additional classification and wage rates conformed under paragraph (a)(1)(ii) of this section) and the Davis-Bacon poster (WH-1321) shall be posted at all times by the contractor and its subcontractors at the site of the work in a prominent and accessible place where it can be easily seen by the workers.

The contracting officer shall require that any class of laborers or mechanics, including helpers, which is not listed in the wage determination and which is to be employed under the contract shall be classified in conformance with the wage determination. The contracting officer shall approve an additional classification and wage rate and fringe benefits therefore only when the following criteria have been met:

The work to be performed by the classification requested is not performed by a classification in the wage determination; and

The classification is utilized in the area by the construction industry; and

The proposed wage rate, including any bona fide fringe benefits, bears a reasonable relationship to the wage rates contained in the wage determination.

If the contractor and the laborers and mechanics to be employed in the classification (if known), or their representatives, and the contracting officer agree on the classification and wage rate (including the amount designated for fringe benefits where appropriate), a report of the action taken shall be sent by the contracting officer to the Administrator of the Wage and Hour Division, Employment Standards Administration, U.S. Department of Labor, Washington, D.C. 20210. The Administrator, or an authorized representative, will approve, modify, or disapprove every additional classification action within 30 days of receipt and so advise the contracting officer or will notify the contracting officer within the 30-day period that additional time is necessary.

In the event the contractor, the laborers or mechanics to be employed in the classification or their representatives, and the contracting officer do not agree on the proposed classification and wage rate (including the amount designated for fringe benefits, where appropriate), the contracting officer shall refer the questions, including the views of all interested parties and the recommendation of the contracting officer, to the Administrator for determination. The Administrator, or an authorized representative, will issue a determination within 30 days of receipt and so advise the contracting officer or will notify the contracting officer within the 30-day period that additional time is necessary.

The wage rate (including fringe benefits where appropriate) determined pursuant to paragraphs (a)(1)(ii) (B) or (C) of this section, shall be paid to all workers performing work in the classification under this contract from the first day on which work is performed in the classification.

Whenever the minimum wage rate prescribed in the contract for a class of laborers or mechanics includes a fringe benefit which is not expressed as an hourly rate, the contractor shall either pay the benefit as stated in the wage determination or shall pay another bona fide fringe benefit or an hourly cash equivalent thereof.

If the contractor does not make payments to a trustee or other third person, the contractor may consider as part of the wages of any laborer or mechanic the amount of any costs reasonably anticipated in providing bona fide fringe benefits under a plan or program, Provided, That the Secretary of Labor has found, upon the written request of the contractor, that the applicable standards of the Davis-Bacon Act have been met. The Secretary of Labor may require the contractor to set aside in a separate account assets for the meeting of obligations under the plan or program.

By way of a further example, a system 100 of the present disclosure may be configured to act in relation to statute 29 C.F.R. §5.23, which concerns elements that make up the prevailing wage requirements for contracts subject to Davis-Bacon Act, Davis-Bacon Related Acts, and/or Collective Bargaining Agreements.

The fringe benefits provisions of the 1964 amendments to the Davis-Bacon Act are, in part, as follows:

As used in this Act the term “wages”, “scale of wages”, “wage rates”, “minimum wages”, and “prevailing wages” shall include—

The basic hourly rate of pay; and

The amount of—A) The rate of contribution irrevocably made by a contractor or subcontractor to a trustee or to a third person pursuant to a fund, plan, or program; and (B) The rate of costs to the contractor or subcontractor which may be reasonably anticipated in providing benefits to laborers and mechanics pursuant to an enforceable commitment to carry out a financially responsible plan or program which was communicated in writing to the laborers and mechanics affected, for medical or hospital care, pensions on retirement or death, compensation for injuries or illness resulting from occupational activity, or insurance to provide any of the foregoing, for unemployment benefits, life insurance, disability and sickness insurance, or accident insurance, for vacation and holiday pay, for defraying costs of apprenticeship or other similar programs, or for other bona fide fringe benefits, but only where the contractor or subcontractor is not required by other Federal, State, or local law to provide any of such benefits * * *.

By way of yet a further example, a system 100 of the present disclosure may be configured to act in relation to statute 29 C.F.R. §5.24, which concerns elements that make up the basic hourly rate of pay requirements for contracts subject to Davis-Bacon Act, Davis-Bacon Related Acts, and/or Collective Bargaining Agreements.

“The basic hourly rate of pay” is that part of a laborer's or mechanic's wages which the Secretary of Labor would have found and included in wage determinations prior to the 1964 amendments. The Secretary of Labor is required to continue to make a separate finding of this portion of the wage. In general, this portion of the wage is the cash payment made directly to the laborer or mechanic. It does not include fringe benefits.

By way of yet a further example, a system 100 of the present disclosure may be configured to act in relation to statute 29 C.F.R. §5.25, which concerns elements that make up rate of contribution or cost for fringe benefits requirements for contracts subject to Davis-Bacon Act, Davis-Bacon Related Acts, and/or Collective Bargaining Agreements.

Under the amendments, the Secretary is obligated to make a separate finding of the rate of contribution or cost of fringe benefits. Only the amount of contributions or costs for fringe benefits which meet the requirements of the act will be considered by the Secretary. These requirements are discussed in this subpart.

The rate of contribution or cost is ordinarily an hourly rate, and will be reflected in the wage determination as such. In some cases, however, the contribution or cost for certain fringe benefits may be expressed in a formula or method of payment other than an hourly rate. In such cases, the Secretary may in his discretion express in the wage determination the rate of contribution or cost used in the formula or method or may convert it to an hourly rate of pay whenever he finds that such action would facilitate the administration of the Act. See §5.5(a)(1)(i) and (iii).

By way of yet a further example, a system 100 of the present disclosure may be configured to act in relation to statute 29 C.F.R. §5.26, which concerns definition for “contribution irrevocably made” “to a trustee or to a third person” requirement for fringe benefits for contracts subject to Davis-Bacon Act, Davis-Bacon Related Acts, and/or Collective Bargaining Agreements.

Under the fringe benefits provisions (section 1(b)(2) of the Act) the amount of contributions for fringe benefits must be made to a trustee or to a third person irrevocably. The “third person” must be one who is not affiliated with the contractor or subcontractor. The trustee must assume the usual fiduciary responsibilities imposed upon trustees by applicable law. The trust or fund must be set up in such a way that in no event will the contractor or subcontractor be able to recapture any of the contributions paid in or any way divert the funds to his own use or benefit. Although contributions made to a trustee or third person pursuant to a benefit plan must be irrevocably made, this does not prevent return to the contractor or subcontractor of sums which he had paid in excess of the contributions actually called for by the plan, as where such excess payments result from error or from the necessity of making payments to cover the estimated cost of contributions at a time when the exact amount of the necessary contributions under the plan is not yet ascertained. For example, a benefit plan may provide for definite insurance benefits for employees in the event of the happening of a specified contingency such as death, sickness, accident, etc., and may provide that the cost of such definite benefits, either in full or any balance in excess of specified employee contributions, will be borne by the contractor or subcontractor. In such a case the return by the insurance company to the contractor or subcontractor of sums paid by him in excess of the amount required to provide the benefits which, under the plan, are to be provided through contributions by the contractor or subcontractor, will not be deemed a recapture or diversion by the employer of contributions made pursuant to the plan. (See Report of the Senate Committee on Labor and Public Welfare, S. Rep. No. 963, 88th Cong., 2d Sess., p. 5.)

By way of yet a further example, a system 100 of the present disclosure may be configured to act in relation to statute 29 C.F.R. §5.27, which concerns definition for “fund, plan, or program” requirement for fringe benefit for contracts subject to Davis-Bacon Act, Davis-Bacon Related Acts, and/or Collective Bargaining Agreements.

The contributions for fringe benefits must be made pursuant to a fund, plan or program (sec. 1(b)(2)(A) of the act). The phrase “fund, plan, or program” is merely intended to recognize the various types of arrangements commonly used to provide fringe benefits through employer contributions. The phrase is identical with language contained in section 3(1) of the Welfare and Pension Plans Disclosure Act. In interpreting this phrase, the Secretary will be guided by the experience of the Department in administering the latter statute. (See Report of Senate Committee on Labor and Public Welfare, S. Rep. No. 963, 88th Cong., 2d Sess., p. 5.)

By way of yet a further example, a system 100 of the present disclosure may be configured to act in relation to statute 29 C.F.R. §5.28, which concerns requirements for unfunded fringe benefit plans for contracts subject to Davis-Bacon Act, Davis-Bacon Related Acts, and/or Collective Bargaining Agreements.

The costs to a contractor or subcontractor which may be reasonably anticipated in providing benefits of the types described in the act pursuant to an enforceable commitment to carry out a financially responsible plan or program, are considered fringe benefits within the meaning of the act (see 1(b) (2) (B) of the act). The legislative history suggests that these provisions were intended to permit the consideration of fringe benefits meeting, among others, these requirements and which are provided from the general assets of a contractor or subcontractor. (Report of the House Committee on Education and Labor, H. Rep. No. 308, 88th Cong., 1st Sess., p. 4.)

No type of fringe benefit is eligible for consideration as a so-called unfunded plan unless:
it could be reasonably anticipated to provide benefits described in the act;
it represents a commitment that can be legally enforced;
it is carried out under a financially responsible plan or program; and
the plan or program providing the benefits has been communicated in writing to the laborers and mechanics affected. (See S. Rep. No. 963, p. 6.)

It is in this manner that the act provides for the consideration of unfunded plans or programs in finding prevailing wages and in ascertaining compliance with the Act. At the same time, however, there is protection against the use of this provision as a means of avoiding the act's requirements. The words “reasonably anticipated” are intended to require that any unfunded plan or program be able to withstand a test which can perhaps be best described as one of actuarial soundness. Moreover, as in the case of other fringe benefits payable under the act, an unfunded plan or program must be “bona fide” and not a mere simulation or sham for avoiding compliance with the act. (See S. Rep. No. 963, p. 6.) The legislative history suggests that in order to insure against the possibility that these provisions might be used to avoid compliance with the act, the committee contemplates that the Secretary of Labor in carrying out his responsibilities under Reorganization Plan No. 14 of 1950, may direct a contractor or subcontractor to set aside in an account assets which, under sound actuarial principles, will be sufficient to meet the future obligation under the plan. The preservation of this account for the purpose intended would, of course, also be essential. (S. Rep. No. 963, p. 6.) This is implemented by the contractual provisions required by §5.5(a)(1)(iv).

By way of yet a further example, a system 100 of the present disclosure may be configured to act in relation to statute 29 C.F.R. §5.29, which concerns the types of benefits which can meet the fringe benefit requirements for contracts subject to Davis-Bacon Act, Davis-Bacon Related Acts, and/or Collective Bargaining Agreements.

The act lists all types of fringe benefits which the Congress considered to be common in the construction industry as a whole. These include the following: Medical or hospital care, pensions on retirement or death, compensation for injuries or illness resulting from occupational activity, or insurance to provide any of the foregoing, unemployment benefits, life insurance, disability and sickness insurance, or accident insurance, vacation and holiday pay, defrayment of costs of apprenticeship or other similar programs, or other bona fide fringe benefits, but only where the contractor or subcontractor is not required by other Federal, State, or local law to provide any of such benefits.

The legislative history indicates that it was not the intent of the Congress to impose specific standards relating to administration of fringe benefits. It was assumed that the majority of fringe benefits arrangements of this nature will be those which are administered in accordance with requirements of section 302(c)(5) of the National Labor Relations Act, as amended (S. Rep. No. 963, p. 5).

The term “other bona fide fringe benefits” is the so-called “open end” provision. This was included so that new fringe benefits may be recognized by the Secretary as they become prevailing. It was pointed out that a particular fringe benefit need not be recognized beyond a particular area in order for the Secretary to find that it is prevailing in that area. (S. Rep. No. 963, p. 6).

The legislative reports indicate that, to insure against considering and giving credit to any and all fringe benefits, some of which might be illusory or not genuine, the qualification was included that such fringe benefits must be “bona fide” (H. Rep. No. 308, p. 4; S. Rep. No. 963, p. 6). No difficulty is anticipated in determining whether a particular fringe benefit is “bona fide” in the ordinary case where the benefits are those common in the construction industry and which are established under a usual fund, plan, or program. This would be typically the case of those fringe benefits listed in paragraph (a) of this section which are funded under a trust or insurance program. Contractors may take credit for contributions made under such conventional plans without requesting the approval of the Secretary of Labor under §5.5(a)(1)(iv).

Where the plan is not of the conventional type described in the preceding paragraph, it will be necessary for the Secretary to examine the facts and circumstances to determine whether they are “bona fide” in accordance with requirements of the act. This is particularly true with respect to unfunded plans. Contractors or subcontractors seeking credit under the act for costs incurred for such plans must request specific permission from the Secretary under §5.5(a)(1)(iv).

The act excludes fringe benefits which a contractor or subcontractor is obligated to provide under other Federal, State, or local law. No credit may be taken under the act for the payments made for such benefits. For example, payment for workmen's compensation insurance under either a compulsory or elective State statute are not considered payments for fringe benefits under the Act. While each situation must be separately considered on its own merits, payments made for travel, subsistence or to industry promotion funds are not normally payments for fringe benefits under the Act. The omission in the Act of any express reference to these payments, which are common in the construction industry, suggests that these payments should not normally be regarded as bona fide fringe benefits under the Act.

By way of yet a further example, a system 100 of the present disclosure may be configured to act in relation to statute 29 C.F.R. §5.30, which provides a sample of the types of wage determinations for contracts subject to Davis-Bacon Act, Davis-Bacon Related Acts, and/or Collective Bargaining Agreements.

When fringe benefits are prevailing for various classes of laborers and mechanics in the area of proposed construction, such benefits are includable in any Davis-Bacon wage determination. Illustrations, contained in paragraph (c) of this section, demonstrate some of the different types of wage determinations which may be made in such cases.

Wage determinations of the Secretary of Labor under the act do not include fringe benefits for various classes of laborers and mechanics whenever such benefits do not prevail in the area of proposed construction. When this occurs, the wage determination will contain only the basic hourly rates of pay that are only the cash wages that are prevailing for the various classes of laborers and mechanics. An illustration of this situation is contained in paragraph (c) of this section.

Illustrations:

| | | Fringe benefits payments | | | | |
|---|---|---|---|---|---|---|
| Classes | Basic hourly rates | Health and welfare | Pensions | Vacations | Apprenticeship program | Others |

| | | | | | |
|---|---|---|---|---|---|
| Laborers | $3.25 | | | | |
| Carpenters | 4.00 | $0.15 | | | |
| Painters | 3.90 | .15 | $0.10 | $0.20 | |
| Electricians | 4.85 | .10 | .15 | | |
| Plumbers | 4.95 | .15 | .20 | | $0.05 |
| Ironworkers | 4.60 | | | .10 | |

(It should be noted this format is not necessarily in the exact form in which determinations will issue; it is for illustrative purposes only.)

By way of yet a further example, a system 100 of the present disclosure may be configured to act in relation to statute 29 C.F.R. §5.31, which concerns elements for meeting wage determination obligations for contracts subject to Davis-Bacon Act, Davis-Bacon Related Acts, and/or Collective Bargaining Agreements.

A contractor or subcontractor performing work subject to a Davis-Bacon wage determination may discharge his minimum wage obligations for the payment of both straight time wages and fringe benefits by paying in cash, making payments or incurring costs for “bona fide” fringe benefits of the types listed in the applicable wage determination or otherwise found prevailing by the Secretary of Labor, or by a combination thereof.

A contractor or subcontractor may discharge his obligations for the payment of the basic hourly rates and the fringe benefits where both are contained in a wage determination applicable to his laborers or mechanics in the following ways:

By paying not less than the basic hourly rate to the laborers or mechanics and by making the contributions for the fringe benefits in the wage determinations, as specified therein. For example, in the illustration contained in paragraph (c) of §5.30, the obligations for “painters” will be met by the payment of a straight time hourly rate of not less than $3.90 and by contributing not less than at the rate of 15 cents an hour for health and welfare benefits, 10 cents an hour for pensions, and 20 cents an hour for vacations; or

By paying not less than the basic hourly rate to the laborers or mechanics and by making contributions for “bona fide” fringe benefits in a total amount not less than the total of the fringe benefits required by the wage determination. For example, the obligations for “painters” in the illustration in paragraph (c) of §5.30 will be met by the payment of a straight time hourly rate of not less than $3.90 and by contributions of not less than a total of 45 cents an hour for “bona fide” fringe benefits; or

By paying in cash directly to laborers or mechanics for the basic hourly rate and by making an additional cash payment in lieu of the required benefits. For example, where an employer does not make payments or incur costs for fringe benefits, he would meet his obligations for “painters” in the illustration in paragraph (c) of §5.30, by paying directly to the painters a straight time hourly rate of not less than $4.35 ($3.90 basic hourly rate plus 45 cents for fringe benefits); or

As stated in paragraph (a) of this section, the contractor or subcontractor may discharge his minimum wage obligations for the payment of straight time wages and fringe benefits by a combination of the methods illustrated in paragraphs (b)(1) thru (3) of this section. Thus, for example, his obligations for “painters” may be met by an hourly rate, partly in cash and partly in payments or costs for fringe benefits which total not less than $4.35 ($3.90 basic hourly rate plus 45 cents for fringe benefits). The payments in such case may be $4.10 in cash and 25 cents in payments or costs in fringe benefits. Or, they may be $3.75 in cash and 60 cents in payments or costs for fringe benefits. [30 FR 13136, Oct. 15, 1965]

By way of yet a further example, a system 100 of the present disclosure may be configured to act in relation to statute 29 C.F.R. §5.32, which concerns elements for calculating overtime payments on prevailing wages for contracts subject to Davis-Bacon Act, Davis-Bacon Related Acts, and/or Collective Bargaining Agreements.

The act excludes amounts paid by a contractor or subcontractor for fringe benefits in the computation of overtime under the Fair Labor Standards Act, the Contract Work Hours and Safety Standards Act, and the Walsh-Healey Public Contracts Act whenever the overtime provisions of any of these statutes apply concurrently with the Davis-Bacon Act or its related prevailing wage statutes. It is clear from the legislative history that in no event can the regular or basic rate upon which premium pay for overtime is calculated under the aforementioned Federal statutes be less than the amount determined by the Secretary of Labor as the basic hourly rate (i.e. cash rate) under section 1(b)(1) of the Davis-Bacon Act. (See S. Rep. No. 963, p. 7.) Contributions by employees are not excluded from the regular or basic rate upon which overtime is computed under these statutes; that is, an employee's regular or basic straight-time rate is computed on his earnings before any deductions are made for the employee's contributions to fringe benefits. The contractor's contributions or costs for fringe benefits may be excluded in computing such rate so long as the exclusions do not reduce the regular or basic rate below the basic hourly rate contained in the wage determination.

The legislative report notes that the phrase “contributions irrevocably made by a contractor or subcontractor to a trustee or to a third person pursuant to a fund, plan, or program” was added to the bill in Committee. This language in essence conforms to the overtime provisions of section 7(d)(4) of the Fair Labor Standards Act, as amended. The intent of the committee was to prevent any avoidance of overtime requirements under existing law. See H. Rep. No. 308, p. 5.

The act permits a contractor or subcontractor to pay a cash equivalent of any fringe benefits found prevailing by the Secretary of Labor. Such a cash equivalent would also be excludable in computing the regular or basic rate under the Federal overtime laws mentioned in paragraph (a). For example, the W construction contractor pays his laborers or mechanics $3.50 in cash under a wage determination of the Secretary of Labor which requires a basic hourly rate of $3 and a fringe benefit contribution of 50 cents. The contractor pays the 50 cents in cash because he made no payments and incurred no costs for fringe benefits. Overtime compensation in this case would be computed on a regular or basic rate of $3.00 an hour. However, in some cases a question of fact may be presented in ascertaining whether or not a cash payment made to laborers or mechanics is actually in lieu of a fringe benefit or is simply part of their straight time cash wage. In the latter situation, the cash payment is not excludable in computing overtime compensation. Consider the examples set forth in paragraphs (c)(2) and (3) of this section.

The X construction contractor has for some time been paying $3.25 an hour to a mechanic as his basic cash wage plus 50 cents an hour as a contribution to a welfare and pension plan. The Secretary of Labor determines that a basic hourly rate of $3 an hour and a fringe benefit contribution of 50 cents are prevailing. The basic hourly rate or regular rate for overtime purposes would be $3.25, the rate actually paid as a basic cash wage for the employee of X, rather than the $3 rate determined as prevailing by the Secretary of Labor.

Under the same prevailing wage determination, discussed in paragraph (c)(2) of this section, the Y construction contractor who has been paying $3 an hour as his basic cash wage on which he has been computing overtime compensation reduces the cash wage to $2.75 an hour but computes his costs of benefits under section 1(b)(2)(B) as $1 an hour. In this example the regular or basic hourly rate would continue to be $3 an hour. See S. Rep. No. 963, p. 7.

By way of yet a further example, a system 100 of the present disclosure may be configured to act in relation to statute 29 C.F.R. §4.173, which concerns requirements for employers to meet vacation fringe benefits for contracts subject to Davis-Bacon Act, Davis-Bacon Related Acts, and/or Collective Bargaining Agreements.

I. Determining Length of Service for Vacation Eligibility.

It has been found that for many types of service contracts performed at Federal facilities a successor contractor will utilize the employees of the previous contractor in the performance of the contract. The employees typically work at the same location providing the same services to the same clientele over a period of years, with periodic, often annual, changes of employer. The incumbent contractor, when bidding on a contract, must consider his liability for vacation benefits for those workers in his employ. If prospective contractors who plan to employ the same personnel were not required to furnish these employees with the same prevailing vacation benefits, it would place the incumbent contractor at a distinct competitive disadvantage as well as denying such employees entitlement to prevailing vacation benefits.

Accordingly, most vacation fringe benefit determinations issued under the Act require an employer to furnish to employees working on the contract a specified amount of paid vacation upon completion of a specified length of service with a contractor or successor. This requirement may be stated in the determination, for example, as “one week paid vacation after one year of service with a contractor or successor” or by a determination which calls for “one week's paid vacation after one year of service”. Unless specified otherwise in an applicable fringe benefit determination, an employer must take the following two factors into consideration in determining when an employee has completed the required length of service to be eligible for vacation benefits:

The total length of time spent by an employee in any capacity in the continuous service of the present (successor) contractor, including both the time spent in performing on regular commercial work and the time spent in performing on the Government contract itself, and

Where applicable, the total length of time spent in any capacity as an employee in the continuous service of any predecessor contractor(s) who carried out similar contract functions at the same Federal facility.

The application of these principles may be illustrated by the example given above of a fringe benefit determination calling for “one week paid vacation after one year of service with a contractor or successor”. In that example, if a contractor has an employee who has worked for him for 18 months on regular commercial work and only for 6 months on a Government service contract, that employee would be eligible for the one week vacation since his total service with the employer adds up to more than 1 year. Similarly, if a contractor has an employee who worked for 16 months under a janitorial service contract at a particular Federal base for two different predecessor contractors, and only 8 months with the present employer, that employee would also be considered as meeting the “after one year of service” test and would thus be eligible for the specified vacation.

The “contractor or successor” requirement set forth in paragraph (a)(1) of this section is not affected by the fact that a different contracting agency may have contracted for the services previously or by the agency's dividing and/or combining the contract services. However, prior service as a Federal employee is not counted toward an employee's eligibility for vacation benefits under fringe benefit determinations issued pursuant to the Act.

Some fringe benefit determinations may require an employer to furnish a specified amount of paid vacation upon completion of a specified length of service with the employer, for example, “one week paid vacation after one year of service with an employer”. Under such determinations, only the time spent in performing on commercial work and on Government contract work in the employment of the present contractor need be considered in computing the length of service for purposes of determining vacation eligibility.

Whether or not the predecessor contract(s) was covered by a fringe benefit determination is immaterial in determining whether the one year of service test has been met. This qualification refers to work performed before, as well as after, an applicable fringe benefit determination is incorporated into a contract. Also, the fact that the labor standards in predecessor service contract(s) were only those required under the Fair Labor Standards Act has no effect on the applicable fringe benefit determination contained in a current contract.

II. Eligibility Requirement—Continuous Service.

Under the principles set forth above, if an employee's total length of service adds up to at least one year, the employee is eligible for vacation with pay. However, such service must have been rendered continuously for a period of not less than one year for vacation eligibility. The term “continuous service” does not require the combination of two entirely separate periods of employment. Whether or not there is a break in the continuity of service so as to make an employee ineligible for a vacation benefit is dependent upon all the facts in the particular case. No fixed time period has been established for determining whether an employee has a break in service. Rather, as illustrated below, the reason(s) for an employee's absence from work is the primary factor in determining whether a break in service occurred.

In cases where employees have been granted leave with or without pay by their employer, or are otherwise absent with permission for such reasons as sickness or injury, or otherwise perform no work on the contract because of reasons beyond their control, there would not be a break in service. Likewise, the absence from work for a few days, with or without notice, does not constitute a break in service, without a formal termination of employment. The following specific examples are illustrative situations where it has been determined that a break in service did not occur:

An employee absent for five months due to illness but employed continuously for three years.

A strike after which employees returned to work.

An interim period of three months between contracts caused by delays in the procurement process during which time personnel hired directly by the Government performed the necessary services. However, the successor contractor in this case was not held liable for vacation benefits for those employees who had anniversary dates of employment during the interim period because no employment relationship existed during such period.

A mess hall closed three months for renovation. Contractor employees were considered to be on temporary layoff during the renovation period and did not have a break in service.

Where an employee quits, is fired for cause, or is otherwise terminated (except for temporary layoffs), there would be a break in service even if the employee were rehired at a later date. However, an employee may not be discharged and rehired as a subterfuge to evade the vacation requirement.

III. Vesting and Payment of Vacation Benefits.

In the example given in paragraph (a)(1) of this section of a fringe benefit determination calling for “one week paid vacation after 1 year of service with a contractor or successor”, an employee who renders the “one year of service” continuously becomes eligible for the “one week paid vacation” (i.e., 40 hours of paid vacation, unless otherwise specified in an applicable wage determination) upon his anniversary date of employment and upon each succeeding anniversary date thereafter. However, there is no accrual or vesting of vacation eligibility before the employee's anniversary date of employment, and no segment of time smaller than one year need be considered in computing the employer's vacation liability, unless specifically provided for in a particular fringe benefit determination. For example, an employee who has worked 13 months for an employer subject to such stipulations and is separated without receiving any vacation benefit is entitled only to one full week's (40 hours) paid vacation. He would not be entitled to the additional fraction of one-twelfth of one week's paid vacation for the month he worked in the second year unless otherwise stated in the applicable wage determination. An employee who has not met the “one year of service” requirement would not be entitled to any portion of the “one week paid vacation”.

Eligibility for vacation benefits specified in a particular wage determination is based on completion of the stated period of past service. The individual employee's anniversary date (and each annual anniversary date of employment thereafter) is the reference point for vesting of vacation eligibility, but does not necessarily mean that the employee must be given the vacation or paid for it on the date on which it is vested. The vacation may be scheduled according to a reasonable plan mutually agreed to and communicated to the employees. A “reasonable” plan may be interpreted to be a plan which allows the employer to maintain uninterrupted contract services but allows the employee some choice, by seniority or similar factor, in the scheduling of vacations. However, the required vacation must be given or payment made in lieu thereof before the next anniversary date, before completion of the current contract, or before the employee terminates employment, whichever occurs first.

IV. Contractor Liability for Vacation Benefits.

The liability for an employee's vacation is not prorated among contractors unless specifically provided for under a particular fringe benefit determination. The contractor by whom a person is employed at the time the vacation right vests, i.e., on the employee's anniversary date of employment, must provide the full benefit required by the determination which is applicable on that date. For example, an employee, who had not previously performed similar contract work at the same facility, was first hired by a predecessor contractor on Jul. 1, 1978. July 1 is the employee's anniversary date. The predecessor's contract ended Jun. 30, 1979, but the employee continued working on the contract for the successor. Since the employee did not have an anniversary date of employment during the predecessor's contract, the predecessor would not have any vacation liability with respect to this employee. However, on Jul. 1, 1979 the employee's entitlement to the full vacation benefit vested and the successor contractor would be liable for the full amount of the employee's vacation benefit.

The requirements for furnishing data relative to employee hiring dates in situations where such employees worked for “predecessor” contractors are set forth in §4.6. However, a contractor is not relieved from any obligation to provide vacation benefits because of any difficulty in obtaining such data.

V. Rate Applicable to Computation of Vacation Benefits.

If an applicable wage determination requires that the hourly wage rate be increased during the period of the contract, the rate applicable to the computation of any required vacation benefits is the hourly rate in effect in the workweek in which the actual paid vacation is provided or the equivalent is paid, as the case may be, and would not be the average of the two hourly rates. This rule would not apply to situations where a wage determination specified the method of computation and the rate to be used.

As set forth in §4.172, unless specified otherwise in an applicable fringe benefit determination, service employees must be furnished the required amount of fringe benefits for all hours paid for up to a maximum of 40 hours per week and 2,080 hours per year. Thus, an employee on paid vacation leave would accrue and must be compensated for any other applicable fringe benefits specified in the fringe benefit determination, and if any of the other benefits are furnished in the form of cash equivalents, such equivalents must be included with the applicable hourly wage rate in computing vacation benefits or a cash equivalent therefor. The rules and regulations for computing cash equivalents are set forth in §4.177.

By way of yet a further example, a system 100 of the present disclosure may be configured to act in relation to statute 29 C.F.R. §4.174, which concerns requirements for employers to meet holiday fringe benefits for contracts subject to Davis-Bacon Act, Davis-Bacon Related Acts, and/or Collective Bargaining Agreements.

I. General Determination of Eligibility for Holiday Benefits

Most fringe benefit determinations list a specific number of named holidays for which payment is required. Unless specified otherwise in an applicable determination, an employee who performs any work during the workweek in which a named holiday occurs is entitled to the holiday benefit, regardless of whether the named holiday falls on a Sunday, another day during the workweek on which the employee is not normally scheduled to work, or on the employee's day off. In addition, holiday benefits cannot be denied because the employee has not been employed by the contractor for a designated period prior to the named holiday or because the employee did not work the day before or the day after the holiday, unless such qualifications are specifically included in the determination.

An employee who performs no work during the workweek in which a named holiday occurs is generally not entitled to the holiday benefit. However, an employee who performs no work during the workweek because he is on paid vacation or sick leave in accordance with the terms of the applicable fringe benefit determination is entitled to holiday pay or another day off with pay to substitute for the named holiday. In addition, an employee who performs no work during the workweek because of a layoff does not forfeit his entitlement to holiday benefits if the layoff is merely a subterfuge by the contractor to avoid the payment of such benefits.

The obligation to furnish holiday pay for the named holiday may be discharged if the contractor furnishes another day off with pay in accordance with a plan communicated to the employees involved. However, in such instances the holidays named in the fringe benefit determination are the reference points for determining whether an employee is eligible to receive holiday benefits. In other words, if an employee worked in a workweek in which a listed holiday occurred, the employee is entitled to pay for that holiday. Some determinations may provide for a specific number of holidays without naming them. In such instances the contractor is free to select the holidays to be taken in accordance with a plan communicated to the employees involved, and the agreed-upon holidays are the reference points for determining whether an employee is eligible to receive holiday benefits

II. Determination of Eligibility for Holiday Benefits for Newly Hired Employees

The contractor generally is not required to compensate a newly hired employee for the holiday occurring prior to the hiring of the employee. However, in the one situation where a named holiday falls in the first week of a contract, all employees who work during the first week would be entitled to holiday pay for that day. For example, if a contract to provide services for the period January 1 through December 31 contained a fringe benefit determination listing New Year's Day as a named holiday, and if New Year's Day were officially celebrated on January 2 in the year in question because January 1 fell on a Sunday, employees hired to begin work on January 3 would be entitled to holiday pay for New Year's Day.

III. Payment of Holiday Benefits

A full-time employee who is eligible to receive payment for a named holiday must receive a full day's pay up to hours unless a different standard is used in the fringe benefit determination, such as one reflecting collectively bargained holiday benefit requirements issued pursuant to section 4(c) of the Act or a different historic practice in an industry or locality. Thus, for example, a contractor must furnish 7 hours of holiday pay to a full-time employee whose scheduled workday consists of 7 hours. An employee whose scheduled workday is 10 hours would be entitled to a holiday payment of 8 hours unless a different standard is used in the determination. As discussed in §4.172, such holiday pay must include the full amount of other fringe benefits to which the employee is entitled.

Unless a different standard is used in the wage determination, a full-time employee who works on the day designated as a holiday must be paid, in addition to the amount he ordinarily would be entitled to for that day's work, the cash equivalent of a full-day's pay up to 8 hours or be furnished another day off with pay.

If the fringe benefit determination lists the employee's birthday as a paid holiday and that day coincides with another listed holiday, the contractor may discharge his obligation to furnish payment for the second holiday by either substituting another day off with pay with the consent of the employee, furnishing holiday benefits of an extra day's pay, or if the employee works on the holiday in question, furnish holiday benefits of two extra days' pay.

As stated in paragraph (a)(1) of this section, an employee's entitlement to holiday pay fully vests by working in the workweek in which the named holiday occurs. Accordingly, any employee who is terminated before receiving the full amount of holiday benefits due him must be paid the holiday benefits as a final cash payment.

The rules and regulations for furnishing holiday pay to temporary and part-time employees are discussed in §4.176.

The rules and regulations for furnishing equivalent fringe benefits or cash equivalents in lieu of holiday pay are discussed in §4.177.

By way of yet a further example, a system 100 of the present disclosure may be configured to act in relation to statute 29 C.F.R. §4.175, which concerns requirements for employers to meet health, welfare, and/or pension benefits compliance for contracts subject to Davis-Bacon Act, Davis-Bacon Related Acts, and/or Collective Bargaining Agreements.

I. Determination of the Required Amount of Benefits

Most fringe benefit determinations containing health and welfare and/or pension requirements specify a fixed payment per hour on behalf of each service employee. These payments are usually also stated as weekly or monthly amounts. As set forth in §4.172, unless specified otherwise in the applicable determination such payments are due for all hours paid for, including paid vacation, sick leave, and holiday hours, up to a maximum of 40 hours per week and 2,080 hours per year on each contract. The application of this rule can be illustrated by the following examples:

An employee who works 4 days a week, 10 hours a day is entitled to 40 hours of health and welfare and/or pension fringe benefits. If an employee works 3 days a week, 12 hours a day, then such employee is entitled to 36 hours of these benefits.

An employee who works 32 hours in a workweek and also receives 8 hours of holiday pay is entitled to the maximum of 40 hours of health and welfare and/or pension payments in that workweek. If the employee works more than 32 hours and also received 8 hours of holiday pay, the employee is still only entitled to the maximum of 40 hours of health and welfare and/or pension payments.

If an employee is off work for two weeks on vacation and received 80 hours of vacation pay, the employee must also receive payment for the 80 hours of health and welfare and/or pension benefits which accrue during the vacation period.

An employee entitled to two weeks paid vacation who instead works the full 52 weeks in the year, receiving the full 2,080 hours worth of health and welfare and/or pension benefits, would be due an extra 80 hours of vacation pay in lieu of actually taking the vacation; however, such an employee would not be entitled to have an additional 80 hours of health and welfare and/or pension benefits included in his vacation pay.

A fringe benefit determination calling for a specified benefit such as health insurance contemplates a fixed and definite contribution to a “bona fide” plan (as that term is defined in §4.171) by an employer on behalf of each employee, based on the monetary cost to the employer rather than on the level of benefits provided. Therefore, in determining compliance with an applicable fringe benefit determination, the amount of the employer's contribution on behalf of each individual employee governs. Thus, as set forth in §4.172, if a determination should require a contribution to a plan providing a specified fringe benefit and that benefit can be obtained for less than the required contribution, it would be necessary for the employer to make up the difference in cash to the employee, or furnish equivalent benefits, or a combination thereof. The following illustrates the application of this principle: A fringe benefit determination requires a rate of $36.40 per month per employee for a health insurance plan. The employer obtains the health insurance coverage specified at a rate of $20.45 per month for a single employee, $30.60 for an employee with spouse, and $40.90 for an employee with a family. The employer is required to make up the difference in cash or equivalent benefits to the first two classes of employees in order to satisfy the determination, notwithstanding that coverage for an employee would be automatically changed by the employer if the employee's status should change (e.g., single to married) and notwithstanding that the employer's average contribution per employee may be equal to or in excess of $36.40 per month.

In determining eligibility for benefits under certain wage determinations containing hours or length of service requirements (such as having to work 40 hours in the preceding month), the contractor must take into account time spent by employees on commercial work as well as time spent on the Government contract.

II. Determinations that Provide in Terms of Average Cost

Some fringe benefit determinations specifically provide for health and welfare and/or pension benefits in terms of average cost. Under this concept, a contractor's contributions per employee to a “bona fide” fringe benefit plan are permitted to vary depending upon the individual employee's marital or employment status. However, the firm's total contributions for all service employees enrolled in the plan must average at least the fringe benefit determination requirement per hour per service employee. If the contractor's contributions average less than the amount required by the determination, then the firm must make up the deficiency by making cash equivalent payments or equivalent fringe benefit payments to all service employees in the plan who worked on the contract during the payment period. Where such deficiencies are made up by means of cash equivalent payments, the payments must be made promptly on the following payday. The following illustrates the application of this principle: The determination requires an average contribution of $0.84 an hour. The contractor makes payments to bona fide fringe benefit plans on a monthly basis. During a month the firm contributes $15,000 for the service employees employed on the contract who are enrolled in the plan, and a total of 20,000 man-hours had been worked by all service employees during the month. Accordingly, the firm's average cost would have been $15,000-20,000 hours or $0.75 per hour, resulting in a deficiency of $0.09 per hour. Therefore, the contractor owes the service employees in the plan who worked on the contract during the month an additional $0.09 an hour for each hour worked on the contract, payable on the next regular payday for wages. Unless otherwise provided in the applicable wage determination, contributions made by the employer for non-service employees may not be credited toward meeting Service Contract Act fringe benefit obligations.

III. Not Enrolled or Excluded Employees

Some health and welfare and pension plans contain eligibility exclusions for certain employees. For example, temporary and part-time employees may be excluded from participating in such plans. Also, employees receiving benefits through participation in plans of an employer other than the Government contractor or by a spouse's employer may be prevented from receiving benefits from the contractor's plan because of prohibitions against “double coverage”. While such exclusions do not invalidate an otherwise bona fide insurance plan, employer contributions to such a plan cannot be considered to be made on behalf of the excluded employees. Accordingly, under fringe benefit determination requirements as described in paragraph (a)(2) of this section, the employees excluded from participation in the health insurance plan must be furnished equivalent bona fide fringe benefits or be paid a cash equivalent payment during the period that they are not eligible to participate in the plan.

It is not required that all employees participating in a fringe benefit plan be entitled to receive benefits from that plan at all times. For example, under some plans, newly hired employees who are eligible to participate in an insurance plan from their first day of employment may be prohibited from receiving benefits from the plan during a specified “waiting period”. Contributions made on behalf of such employees would serve to discharge the contractor's obligation to furnish the fringe benefit. However, if no contributions are made for such employees, no credit may be taken toward the contractor's fringe benefit obligations.

IV. Payment of Health and Welfare and Pension Benefits.

Health and welfare and/or pension payments to a “bona fide” insurance plan or trust program may be made on a periodic payment basis which is not less often than quarterly. However, where fringe benefit determinations contemplate a fixed contribution on behalf of each employee, and a contractor exercises his option to make hourly cash equivalent or differential payments, such payments must be made promptly on the regular payday for wages. (See §4.165.)

The rules and regulations for furnishing health and welfare and pension benefits to temporary and part-time employees are discussed in §4.176.

The rules and regulations for furnishing equivalent fringe benefits or cash equivalents in lieu of health and welfare and pension benefits are discussed in §4.177.

By way of yet a further example, a system 100 of the present disclosure may be configured to act in relation to statute 29 C.F.R. §4.176, which concerns requirements for employers for payment of fringe benefits to temporary and part-time employees working on contracts subject to Davis-Bacon Act, Davis-Bacon Related Acts, and/or Collective Bargaining Agreements.

As set forth in §4.165 (a) (2), the Act makes no distinction, with respect to its compensation provisions, between temporary, part-time, and full-time employees. Accordingly, in the absence of express limitations, the provisions of an applicable fringe benefit determination apply to all temporary and part-time service employees engaged in covered work. However, in general, such temporary and part-time employees are only entitled to an amount of the fringe benefits specified in an applicable determination which is proportionate to the amount of time spent in covered work. The application of these principles may be illustrated by the following examples:

Assuming the paid vacation for full-time employees is one week of 40 hours, a part-time employee working a regularly scheduled workweek of 16 hours is entitled to 16 hours of paid vacation time or its equivalent each year, if all other qualifications are met.

In the case of holidays, a part-time employee working a regularly scheduled workweek of 16 hours would be entitled to two-fifths of the holiday pay due full-time employees. It is immaterial whether or not the holiday falls on a normal workday of the part-time employee. Except as provided in §4.174(b), a temporary or casual employee hired during a holiday week, but after the holiday, would be due no holiday benefits for that week.

Holiday or vacation pay obligations to temporary and part-time employees working an irregular schedule of hours may be discharged by paying such employees a proportion of the holiday or vacation benefits due full-time employees based on the number of hours each such employee worked in the workweek prior to the workweek in which the holiday occurs or, with respect to vacations, the number of hours which the employee worked in the year preceding the employee's anniversary date of employment. For example:

An employee works 10 hours during the week preceding July 4, a designated holiday. The employee is entitled to 10/40 of the holiday pay to which a full-time employee is entitled (i.e., 10/40 times 8=2 hours holiday pay).

A part-time employee works 520 hours during the 12 months preceding the employee's anniversary date. Since the typical number of non-overtime hours in a year of work is 2,080, if a full-time employee would be entitled to one week (40 hours) paid vacation under the applicable fringe benefit determination, then the part-time employee would be entitled to 520/2,080 times 40=10 hours paid vacation.

A part-time employee working a regularly scheduled workweek of 20 hours would be entitled to one-half of the health and welfare and/or pension benefits specified in the applicable fringe benefit determination. Thus, if the determination requires $36.40 per month for health insurance, the contractor could discharge his obligation towards the employee in question by providing a health insurance policy costing $18.20 per month.

A contractor's obligation to furnish the specified fringe benefits to temporary and part-time employees may be discharged by furnishing equivalent benefits, cash equivalents, or a combination thereof in accordance with the rules and regulations set forth in §4.177.

By way of yet a further example, a system 100 of the present disclosure may be configured to act in relation to statute 29 C.F.R. §4.177, which concerns requirements for employers to meet in discharging fringe benefit obligations by equivalent means for contracts subject to Davis-Bacon Act, Davis-Bacon Related Acts, and/or Collective Bargaining Agreements.

I. In General

Section 2(a)(2) of the Act, which provides for fringe benefits that are separate from and in addition to the monetary compensation required under section 2(a)(1), permits an employer to discharge his obligation to furnish the fringe benefits specified in an applicable fringe benefit determination by furnishing any equivalent combinations of “bona fide” fringe benefits or by making equivalent or differential payments in cash. However, credit for such payments is limited to the employer's fringe benefit obligations under section 2(a)(2), since the Act does not authorize any part of the monetary wage required by section 2(a)(1) and specified in the wage determination and the contract, to be offset by the fringe benefit payments or equivalents which are furnished or paid pursuant to section 2(a)(2).

When a contractor substitutes fringe benefits not specified in the fringe benefit determination contained in the contract for fringe benefits which are so specified, the substituted fringe benefits, like those for which the contract provisions are prescribed, must be “bona fide” fringe benefits, as that term is defined in §4.171.

When a contractor discharges his fringe benefit obligation by furnishing, in lieu of those benefits specified in the applicable fringe benefit determination, other “bona fide” fringe benefits, cash payments, or a combination thereof, the substituted fringe benefits and/or cash payments must be “equivalent” to the benefits specified in the determination. As used in this subpart, the terms equivalent fringe benefit and cash equivalent mean equal in terms of monetary cost to the contractor. Thus, as set forth in §4.172, if an applicable fringe benefit determination calls for a particular fringe benefit in a stated amount and the contractor furnished this benefit through contributions in a lesser amount, the contractor must furnish the employee with the difference between the amount stated in the determination and the actual cost of the benefit which the contractor provides. This principle may be illustrated by the example given in §4.175(a) (2).

II. Furnishing Equivalent Fringe Benefits.

A contractor's obligation to furnish fringe benefits which are stated in a specified cash amount may be discharged by furnishing any combination of “bona fide” fringe benefits costing an equal amount. Thus, if an applicable determination specifies that 20 cents per hour is to be paid into a pension fund, this fringe benefit obligation will be deemed to be met if, instead, hospitalization benefits costing not less than 20 cents per hour are provided. The same obligation will be met if hospitalization benefits costing 10 cents an hour and life insurance benefits costing 10 cents an hour are provided. As set forth in §4.171(c), no benefit required to be furnished the employee by any other law, such as workers' compensation, may be credited toward satisfying the fringe benefit requirements of the Act.

A contractor who wishes to furnish equivalent fringe benefits in lieu of those benefits which are not stated in a specified cash amount, such as “one week paid vacation”, must first determine the equivalent cash value of such benefits in accordance with the rules set forth in paragraph (c) of this section.

III. Furnishing Cash Equivalents

Fringe benefit obligations may be discharged by paying to the employee on his regular payday, in addition to the monetary wage required, a cash amount per hour in lieu of the specified fringe benefits, provided such amount is equivalent to the cost of the fringe benefits required. If, for example, an employee's monetary rate under an applicable determination is $4.50 an hour, and the fringe benefits to be furnished are hospitalization benefits costing 20 cents an hour and retirement benefits costing 20 cents an hour, the fringe benefit obligation is discharged if instead of furnishing the required fringe benefits, the employer pays the employee, in cash, 40 cents per hour as the cash equivalent of the fringe benefits in addition to the $4.50 per hour wage rate required under the applicable wage determination.

The hourly cash equivalent of those fringe benefits which are not stated in the applicable determination in terms of hourly cash amounts may be obtained by mathematical computation through the use of pertinent factors such as the monetary wages paid the employee and the hours of work attributable to the period, if any, by which fringe benefits are measured in the determination. If the employee's regular rate of pay is greater than the minimum monetary wage specified in the wage determination and the contract, the former must be used for this computation, and if the fringe benefit determination does not specify any daily or weekly hours of work by which benefits are to be measured, a standard 8-hour day and 40-hour week will be considered applicable. The application of these rules in typical situations is illustrated in paragraphs (c)(3) through (7) of this section.

Where fringe benefits are stated as a percentage of the monetary rate, the hourly cash equivalent is determined by multiplying the stated percentage by the employees' regular or basic (i.e., wage determination) rate of pay, whichever is greater. For example, if the determination calls for a 5 percent pension fund payment and the employee is paid a monetary rate of $4.50 an hour, or if the employee earns $4.50 an hour on a piece-work basis in a particular workweek, the cash equivalent of that payment would be 22½ cents an hour.

If the determination lists a particular fringe benefit in such terms as $8 a week, the hourly cash equivalent is determined by dividing the amount stated in the determination by the number of working hours to which the amount is attributable. For example, if a determination lists a fringe benefit as “pension—$8 a week”, and does not specify weekly hours, the hourly cash equivalent is 20 cents per hour, i.e., $8 divided by 40, the standard number of non-overtime working hours in a week.

In determining the hourly cash equivalent of those fringe benefits which are not stated in the determination in terms of a cash amount, but are stated, for example, as “nine paid holidays per year” or “1 week paid vacation after one year of service”, the employee's hourly monetary rate of pay is multiplied by the number of hours making up the paid holidays or vacation. Unless the hours contemplated in the fringe benefit are specified in the determination, a standard 8-hour day and 40-hour week is considered applicable. The total annual cost so determined is divided by 2,080, the standard number of non-overtime hours in a year of work, to arrive at the hourly cash equivalent. This principle may be illustrated by the following examples:

If a particular determination lists as a fringe benefit “nine holidays per year” and the employee's hourly rate of pay is $4.50, the $4.50 is multiplied by 72 (9 days of 8 hours each) and the result, $324, is then divided by 2,080 to arrive at the hourly cash equivalent, $0.1557 an hour. See §4.174(c)(4).

If the determination requires “one week paid vacation after one year of service”, and the employee's hourly rate of pay is $4.50, the $4.50 is multiplied by 40 and the result, $180.00, is then divided by 2,080 to arrive at the hourly cash equivalent, $0.0865 an hour.

Where an employer elects to pay an hourly cash equivalent in lieu of a paid vacation, which is computed in accordance with paragraph (c)(5) of this section, such payments need commence only after the employee has satisfied the “after one year of service” requirement. However, should the employee terminate employment for any reason before receiving the full amount of vested vacation benefits due, the employee must be paid the full amount of any difference remaining as the final cash payment. For example, an employee becomes eligible for a week's vacation pay on March 1. The employer elects to pay this employee an hourly cash equivalent beginning that date; the employee terminates employment on March 31. Accordingly, as this employee has received only 1/12 of the vacation pay to which he/she is entitled, the employee is due the remaining 11/12 upon termination. As set forth in §4.173(e), the rate applicable to the computation of cash equivalents for vacation benefits is the hourly wage rate in effect at the time such equivalent payments are actually made.

IV. Furnishing a Combination of Equivalent Fringe Benefits and Cash Payments

Fringe benefit obligations may be discharged by furnishing any combination of cash or fringe benefits as illustrated in the preceding paragraphs of this section, in monetary amounts the total of which is equivalent, under the rules therein stated, to the determined fringe benefits specified in the contract. For example, if an applicable determination specifies that 20 cents per hour is to be paid into a pension fund, this fringe benefit obligation will be deemed to be met if instead, hospitalization benefits costing 15 cents an hour and a cash equivalent payment of 5 cents an hour are provided.

V. Effect of Equivalents in Computing Overtime Pay.

Section 6 of the Act excludes from the regular or basic hourly rate of an employee, for purposes of determining the overtime pay to which the employee is entitled under any other Federal law, those fringe benefit payments computed under the Act which are excluded from the regular rate under the Fair Labor Standards Act by provisions of section 7(e) (formerly designated as section 7(d)) of that Act (29 U.S.C. 207(e)). Fringe benefit payments that qualify for such exclusion are described in subpart C of Regulations, 29 C.F.R. part 778. When such fringe benefits are required to be furnished to service employees engaged in contract performance, the right to compute overtime pay in accordance with the above rule is not lost to a contractor or subcontractor because it discharges its obligation under this Act to furnish such fringe benefits through alternative equivalents as provided in this section. If it furnishes equivalent benefits or makes cash payments, or both, to such an employee as authorized herein, the amounts thereof, which discharge the employer's obligation to furnish such specified fringe benefits, may be excluded pursuant to this Act from the employee's regular or basic rate of pay in computing any overtime pay due the employee under any other Federal law. No such exclusion can operate, however, to reduce an employee's regular or basic rate of pay below the monetary wage rate specified as the applicable minimum wage rates under sections 2(a)(1), 2(b), or 4(c) of this Act or under other law or an employment contract.

By way of yet a further example, a system 100 of the present disclosure may be configured to act in relation to statute 29 C.F.R. §4.163.

(a) Section 4(c) of the Act provides that no “contractor or subcontractor under a contract, which succeeds a contract subject to this Act and under which substantially the same services are furnished, shall pay any service employee under such contract less than the wages and fringe benefits, including accrued wages and fringe benefits, and any prospective increases in wages and fringe benefits provided for in a collective-bargaining agreement as a result of arm's-length negotiations, to which such service employees would have been entitled if they were employed under the predecessor contract: Provided, That in any of the foregoing circumstances such obligations shall not apply if the Secretary finds after a hearing in accordance with regulations adopted by the Secretary that such wages and fringe benefits are substantially at variance with those which prevail for services of a character similar in the locality.” Under this provision, the successor contractor's sole obligation is to insure that all service employees are paid no less than the wages and fringe benefits to which such employees would have been entitled if employed under the predecessor's collective bargaining agreement (i.e., irrespective of whether the successor's employees were or were not employed by the predecessor contractor). The obligation of the successor contractor is limited to the wage and fringe benefit requirements of the predecessor's collective bargaining agreement and does not extend to other items such as seniority, grievance procedures, work rules, overtime, etc.

(b) Section 4(c) is Self-Executing.

Under section 4(c), a successor contractor in the same locality as the predecessor contractor is statutorily obligated to pay no less than the wage rates and fringe benefits which were contained in the predecessor contractor's collective bargaining agreement. This is a direct statutory obligation and requirement placed on the successor contractor by section 4(c) and is not contingent or dependent upon the issuance or incorporation in the contract of a wage determination based on the predecessor contractor's collective bargaining agreement. Pursuant to section 4(b) of the Act, a variation has been granted which limits the self-executing application of section 4(c) in the circumstances and under the conditions described in §4.1b(b) of this part. It must be emphasized, however, that the variation in §4.1b(b) is applicable only if the contracting officer has given both the incumbent (predecessor) contractor and the employees' collective bargaining representative notification at least 30 days in advance of any estimated procurement date.

(c) Variance Hearings.

The regulations and procedures for hearings pursuant to section 4(c) of the Act are contained in §4.10 of subpart A and parts 6 and 8 of this title. If, as the result of such hearing, some or all of the wage rate and/or fringe benefit provisions of a predecessor contractor's collective bargaining agreement are found to be substantially at variance with the wage rates and/or fringe benefits prevailing in the locality, the Administrator will cause a new wage determination to be issued in accordance with the decision of the Administrative Law Judge or the Administrative Review Board, as appropriate. Since “it was the clear intent of Congress that any revised wage determinations resulting from a section 4(c) proceeding were to have validity with respect to the procurement involved” (53 Comp. Gen. 401, 402, 1973), the solicitation, or the contract if already awarded, must be amended to incorporate the newly issued wage determination. Such new wage determination shall be made applicable to the contract as of the date of the Administrative Law Judge's decision or, where the decision is reviewed by the Administrative Review Board, the date of that decision. The legislative history of the 1972 Amendments makes clear that the collectively bargained “wages and fringe benefits shall continue to be honored * * * unless and until the Secretary finds, after a hearing, that such wages and fringe benefits are substantially at variance with those prevailing in the locality for like services” (S. Rept. 92-1131, 92nd Cong., 2d Sess. 5). Thus, variance decisions do not have application retroactive to the commencement of the contract.

(d) Sections 2(a) and 4 (c) Must be Read in Conjunction.

The Senate report accompanying the bill which amended the Act in 1972 states that “Sections 2(a)(1), 2(a)(2), and 4(c) must be read in harmony to reflect the statutory scheme.” (S. Rept. 92-1131, 92nd Cong., 2nd Sess. 4.) Therefore, since section 4(c) refers only to the predecessor contractor's collective bargaining agreement, the reference to collective bargaining agreements in sections 2(a)(1) and 2(a)(2) can only be read to mean a predecessor contractor's collective bargaining agreement. The fact that a successor contractor may have its own collective bargaining agreement does not negate the clear mandate of the statute that the wages and fringe benefits called for by the predecessor contractor's collective bargaining agreement shall be the minimum payable under a new (successor) contract nor does it negate the application of a prevailing wage determination issued pursuant to section 2(a) where there was no applicable predecessor collective bargaining agreement. 48 Comp. Gen. 22, 23-24 (1968). In addition, because section 2(a) only applies to covered contracts in excess of $2,500, the requirements of section 4(c) likewise apply only to successor contracts which may be in excess of $2,500. However, if the successor contract is in excess of $2,500, section 4(c) applies regardless of the amount of the predecessor contract. (See §§4.141-4.142 for determining contract amount.)

(e) The Operative Words of Section 4(c) Refer to “Contract” not “Contractor”.

Section 4(c) begins with the language, “[n]o contractor or subcontractor under a contract, which succeeds a contract subject to this Act” (emphasis supplied). Thus, the statute is applicable by its terms to a successor contract without regard to whether the successor contractor was also the predecessor contractor. A contractor may become its own successor because it was the successful bidder on a recompetition of an existing contract, or because the contracting agency exercises an option or otherwise extends the term of the existing contract, etc. (See §§4.143-4.145.) Further, since sections 2(a) and 4(c) must be read in harmony to reflect the statutory scheme, it is clear that the provisions of section 4(c) apply whenever the Act or the regulations require that a new wage determination be incorporated into the contract (53 Comp. Gen. 401, 404-6 (1973)).

(f) Collective Bargaining Agreement Must be Applicable to Work Performed on the Predecessor Contract.

Section 4(c) will be operative only if the employees who worked on the predecessor contract were actually paid in accordance with the wage and fringe benefit provisions of a predecessor contractor's collective bargaining agreement. Thus, for example, section 4(c) would not apply if the predecessor contractor entered into a collective bargaining agreement for the first time, which did not become effective until after the expiration of the predecessor contract. Likewise, the requirements of section 4(c) would not apply if the predecessor contractor's collective bargaining agreement applied only to other employees of the firm and not to the employees working on the contract.

(g) Contract Reconfigurations.

As a result of changing priorities, mission requirements, or other considerations, contracting agencies may decide to restructure their support contracts. Thus, specific contract requirements from one contract may be broken out and placed in a new contract or combined with requirements from other contracts into a consolidated contract. The protections afforded service employees under section 4(c) are not lost or negated because of such contract reconfigurations, and the predecessor contractor's collectively bargained rates follow identifiable contract work requirements into new or consolidated contracts, provided that the new or consolidated contract is for services which were furnished in the same locality under a predecessor contract. See §4.163(i). However, where there is more than one predecessor contract to the new or consolidated contract, and where the predecessor contracts involve the same or similar function(s) of work, using substantially the same job classifications, the predecessor contract which covers the greater portion of the work in such function(s) shall be deemed to be the predecessor contract for purposes of section 4(c), and the collectively bargained wages and fringe benefits under that contract, if any, shall be applicable to such function(s). This limitation on the application of section 4(c) is necessary and proper in the public interest and is in accord with the remedial purpose of the Act to protect prevailing labor standards.

(h) Interruption of Contract Services.

Other than the requirement that substantially the same services be furnished, the requirement for arm's-length negotiations and the provision for variance hearings, the Act does not impose any other restrictions on the application of section 4(c). Thus, the application of section 4(c) is not negated because the contracting authority may change and the successor contract is awarded by a different contracting agency. Also, there is no requirement that the successor contract commence immediately after the completion or termination of the predecessor contract, and an interruption of contract services does not negate the application of section 4(c). Contract services may be interrupted because the Government facility is temporarily closed for renovation, or because a predecessor defaulted on the contract or because a bid protest has halted a contract award requiring the Government to perform the services with its own employees. In all such cases, the requirements of section 4(c) would apply to any successor contract which may be awarded after the temporary interruption or hiatus. The basic principle in all of the preceding examples is that successorship provisions of section 4(c) apply to the full term successor contract. Therefore, temporary interim contracts, which allow a contracting agency sufficient time to solicit bids for a full term contract, also do not negate the application of section 4(c) to a full term successor contract.

(i) Place of Performance.

The successorship requirements of section 4(c) apply to all contracts for substantially the same services as were furnished under a predecessor contract in the same locality. As stated in §4.4(a)(2), a wage determination incorporated in the contract shall be applicable thereto regardless of whether the successful contractor subsequently changes the place(s) of contract performance. Similarly, the application of section 4(c) (and any wage determination issued pursuant to section 4(c) and included in the contract) is not negated by the fact that a successor prime contractor subsequently changes the place(s) of contract performance or subcontracts any part of the contract work to a firm which performs the work in a different locality.

(j) Interpretation of Wage and Fringe Benefit Provisions of Wage Determinations Issued Pursuant to Sections 2(a) and 4(c).

Wage determinations which are issued for successor contracts subject to section 4(c) are intended to accurately reflect the rates and fringe benefits set forth in the predecessor's collective bargaining agreement. However, failure to include in the wage determination any job classification, wage rate, or fringe benefit encompassed in the collective bargaining agreement does not relieve the successor contractor of the statutory requirement to comply at a minimum with the terms of the collective bargaining agreement insofar as wages and fringe benefits are concerned. Since the successor's obligations are governed by the terms of the collective bargaining agreement, any interpretation of the wage and fringe benefit provisions of the collective bargaining agreement where its provisions are unclear must be based on the intent of the parties to the collective bargaining agreement, provided that such interpretation is not violative of law. Therefore, some of the principles discussed in §§4.170 through 4.177 regarding specific interpretations of the fringe benefit provisions of prevailing wage determinations may not be applicable to wage determinations issued pursuant to section 4(c). As provided in section 2(a)(2), a contractor may satisfy its fringe benefit obligations under any wage determination “by furnishing any equivalent combinations of fringe benefits or by making equivalent or differential payments in cash” in accordance with the rules and regulations set forth in §4.177 of this subpart.

(k) No provision of this section shall be construed as permitting a successor contractor to pay its employees less than the wages and fringe benefits to which such employees would have been entitled under the predecessor contractor's collective bargaining agreement. Thus, some of the principles discussed in §4.167 may not be applicable in section 4(c) successorship situations. For example, unless the predecessor contractor's collective bargaining agreement allowed the deduction from employees' wages of the reasonable cost or fair value for providing board, lodging, or other facilities, the successor may not include such costs as part of the applicable minimum wage specified in the wage determination. Likewise, unless the predecessor contractor's agreement allowed a tip credit (§4.6(q)), the successor contractor may not take a tip credit toward satisfying the minimum wage requirements under sections 2(a) (1) and 4(c).

By way of yet a further example, a system 100 of the present disclosure may be configured to act in relation to statute 29 C.F.R. §4.6(b)(2).

(i) If there is such a wage determination attached to this contract, the contracting officer shall require that any class of service employee which is not listed therein and which is to be employed under the contract (i.e., the work to be performed is not performed by any classification listed in the wage determination), be classified by the contractor so as to provide a reasonable relationship (i.e., appropriate level of skill comparison) between such unlisted classifications and the classifications listed in the wage determination. Such conformed class of employees shall be paid the monetary wages and furnished the fringe benefits as are determined pursuant to the procedures in this section.

(ii) Such conforming procedure shall be initiated by the contractor prior to the performance of contract work by such unlisted class of employee. A written report of the proposed conforming action, including information regarding the agreement or disagreement of the authorized representative of the employees involved or, where there is no authorized representative, the employees themselves, shall be submitted by the contractor to the contracting officer no later than 30 days after such unlisted class of employees performs any contract work. The contracting officer shall review the proposed action and promptly submit a report of the action, together with the agency's recommendation and all pertinent information including the position of the contractor and the employees, to the Wage and Hour Division, Employment Standards Administration, U.S. Department of Labor, for review. The Wage and Hour Division will approve, modify, or disapprove the action or render a final determination in the event of disagreement within 30 days of receipt or will notify the contracting officer within 30 days of receipt that additional time is necessary.

(iii) The final determination of the conformance action by the Wage and Hour Division shall be transmitted to the contracting officer who shall promptly notify the contractor of the action taken. Each affected employee shall be furnished by the contractor with a written copy of such determination or it shall be posted as a part of the wage determination.

(iv)(A) The process of establishing wage and fringe benefit rates that bear a reasonable relationship to those listed in a wage determination cannot be reduced to any single formula. The approach used may vary from wage determination to wage determination depending on the circumstances. Standard wage and salary administration practices which rank various job classifications by pay grade pursuant to point schemes or other job factors may, for example, be relied upon. Guidance may also be obtained from the way different jobs are rated under Federal pay systems (Federal Wage Board Pay System and the General Schedule) or from other wage determinations issued in the same locality. Basic to the establishment of any conformable wage rate(s) is the concept that a pay relationship should be maintained between job classifications based on the skill required and the duties performed.

(B) In the case of a contract modification, an exercise of an option or extension of an existing contract, or in any other case where a contractor succeeds a contract under which the classification in question was previously conformed pursuant to this section, a new conformed wage rate and fringe benefits may be assigned to such conformed classification by indexing (i.e., adjusting) the previous conformed rate and fringe benefits by an amount equal to the average (mean) percentage increase (or decrease, where appropriate) between the wages and fringe benefits specified for all classifications to be used on the contract which are listed in the current wage determination, and those specified for the corresponding classifications in the previously applicable wage determination. Where conforming actions are accomplished in accordance with this paragraph prior to the performance of contract work by the unlisted class of employees, the contractor shall advise the contracting officer of the action taken but the other procedures in paragraph (b)(2)(ii) of this section need not be followed.

(C) No employee engaged in performing work on this contract shall in any event be paid less than the currently applicable minimum wage specified under section 6(a)(1) of the Fair Labor Standards Act of 1938, as amended.

(v) The wage rate and fringe benefits finally determined pursuant to paragraphs (b)(2)(i) and (ii) of this section shall be paid to all employees performing in the classification from the first day on which contract work is performed by them in the classification. Failure to pay such unlisted employees the compensation agreed upon by the interested parties and/or finally determined by the Wage and Hour Division retroactive to the date such class of employees commenced contract work shall be a violation of the Act and this contract.

(vi) Upon discovery of failure to comply with paragraphs (b)(2)(i) through (v) of this section, the Wage and Hour Division shall make a final determination of conformed classification, wage rate, and/or fringe benefits which shall be retroactive to the date such class of employees commenced contract work.

Further examples of statute/information that may configure the system to act include, but are not limited to, the Service Contract Act Directory of Occupations, and the Federal Acquisition Regulations (FAR) sections 52.222-43 and 52.222-44. Information used on Standard form (SF) 1444 may be utilized as well.

With reference to FIG. 1, an exemplary system within a computing environment for implementing the disclosure includes a general purpose computing device in the form of a computing system 100, commercially available from Intel, IBM, AMD, Motorola, Cyrix, etc. Components of the computing system 102 may include, but are not limited to, a processing unit 104, a system memory 106, and a system bus 108 that couples various system components including the system memory 106 to the processing unit 104. The system bus 108 may be any of several types of bus structures including a memory bus or memory controller, a peripheral bus, or a local bus using any of a variety of bus architectures.

Computing system 100 typically includes a variety of computer readable media. Computer readable media can be any available media that can be accessed by the computing system 100 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 100.

The system memory 106 includes computer storage media in the form of volatile and/or nonvolatile memory such as read only memory (ROM) 110 and random access memory (RAM) 114. A basic input/output system 112 (BIOS), containing the basic routines that help to transfer information between elements within computing system 100, such as during start-up, is typically stored in ROM 110. RAM 114 typically contains data and/or program modules that are immediately accessible to and/or presently being operated on by processing unit 104. By way of example, and not limitation, an operating system 116, application programs 118, other program modules 120 and program data 122 are shown.

Computing system 100 may also include other removable/non-removable, volatile/nonvolatile computer storage media. By way of example only, a hard disk drive 124 that reads from or writes to non-removable, nonvolatile magnetic media, a magnetic disk drive 126 that reads from or writes to a removable, nonvolatile magnetic disk 128, and an optical disk drive 130 that reads from or writes to a removable, nonvolatile optical disk 132 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 124 is typically connected to the system bus 08 through a non-removable memory interface such as interface 134, and magnetic disk drive 126 and optical disk drive 130 are typically connected to the system bus 108 by a removable memory interface, such as interface 136.

The drives and their associated computer storage media, discussed above, provide storage of computer readable instructions, data structures, program modules and other data for the computing system 100. For example, hard disk drive 124 is illustrated as storing operating system 166, application programs 168, other program modules 170 and program data 172. Note that these components can either be the same as or different from operating system 116, application programs 168, other program modules 120, and program data 122. Operating system 166, application programs 168, other program modules 170, and program data 172 are given different numbers here to illustrate that, at a minimum, they are different copies.

A user may enter commands and information into the computing system 100 through input devices such as a tablet, or electronic digitizer, 138, a microphone 140, a keyboard 142, and pointing device 144, commonly referred to as a mouse, trackball, or touch pad. These and other input devices are often connected to the processing unit 104 through a user input interface 146 that is coupled to the system bus 108, but may be connected by other interface and bus structures, such as a parallel port, game port or a universal serial bus (USB).

A monitor 148 or other type of display device is also connected to the system bus 108 via an interface, such as a video interface 150. The monitor 148 may also be integrated with a touch-screen panel or the like. Note that the monitor and/or touch screen panel can be physically coupled to a housing in which the computing system 100 is incorporated, such as in a tablet-type personal computer. In addition, computers such as the computing system 100 may also include other peripheral output devices such as speakers 154 and printer 182, which may be connected through an output peripheral interface 156 or the like.

Computing system 100 may operate in a networked environment using logical connections to one or more remote computers, such as a remote computing system 158. The remote computing system 158 may be a personal computer (including, but not limited to, mobile electronic devices), a server, a router, a network PC, a peer device or other common network node, and typically includes many or all of the elements described above relative to the computing system 100, although only a memory storage device 160 has been illustrated. The logical connections depicted include a local area network (LAN) 162 connecting through network interface 174 and a wide area network (WAN) 164 connecting via modem 176, but may also include other networks. Such networking environments are commonplace in offices, enterprise-wide computer networks, intranets and the Internet.

For example, in the present embodiment, the computer system 100 may comprise the source machine from which data is being generated/transmitted and the remote computing system 158 may comprise the destination machine. Note however that source and destination machines need not be connected by a network or any other means, but instead, data may be transferred via any media capable of being written by the source platform and read by the destination platform or platforms.

In another example, in the present embodiment, the remote computing system 158 may comprise the source machine from which data is being generated/transmitted and the computer system 100 may comprise the destination machine.

In a further embodiment, in the present disclosure, the computing system 100 may comprise both a source machine from which data is being generated/transmitted and a destination machine and the remote computing system 158 may also comprise both a source machine from which data is being generated/transmitted and a destination machine.

For the purposes of this disclosure, it is appreciated that the terms “device”, “processor based mobile device”, “mobile device”, “electronic device”, “processor based mobile electronic device”, “mobile electronic device”, and “location-capable wireless device” may be synonymous with remote computer 158.

The database 180 may function as the main storage facility utilized by the computing system 100. It is responsible for the storage, organization, and manipulation of data and/or information relating to clients. Data may be pushed and/or sent to the database 180 through a direct connection with the computing system 100 and remote computer 158 or through a connection using LAN 162 or WAN 164. This may include the use of a dashboard on the remote computer 158, which may be used to receive client information from a client on any remote computer 158 utilized by a client. Since the dashboard may be connected to the database 180 through a remote computer, client information may be updated in real-time. The database 180, once having received the updated client information, may, from that point on, use the updated client information in any report generation and/or service that may utilize that client information. The database 180 may comprise one or more components that may also be found in the rest of the computing system 100 such as, but not limited to, a system bus, a network interface, a system memory, etc.

In another embodiment, the database 180 may comprise client information/data and/or other data pertinent to the fringe benefit programs/management information system (MIS) such as, but not limited to hourly wage and fringe benefit rate data, payroll data, benefit program(s)/plan(s) data, employee data, contract data, company/employer data and work location data. The employee census 200 may be representative of one or more sets of client data pertinent to a client's employees (such as the above information).

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

In another embodiment, the system 100 may be connected (wired or wirelessly) to one or more dashboards (not pictured). These dashboards may be operated by the clients and may be used to store and allow access to alter an employee census 200 if any employee data changes. The dashboards may exist on any electronic device such as, but not limited to, a desktop computer, tablet, and mobile cellular electronic device. Any of the dashboards connected to the system may utilize real-time reporting. Once any employee information is altered, the altered information may be sent to the system 100 so that the information in the system 100 may be altered in real-time.

The computing system 100 is tasked with organizing and analyzing client data in order to provide whether a client is or is not compliant with the Davis-Bacon Act of 1931, Davis-Bacon Related Acts, Service Contract Act of 1965 and/or Collective Bargaining Agreements (whether incorporated into a government or commercial contract). The system 100 may also provide, to a client, necessary measures in order to keep a client compliant if a client is not compliant.

The Davis-Bacon Act (DBA) of 1931 and Davis-Bacon Related Acts (DBRA) apply in general to construction contracts, Service Contract Act (SCA) of 1965 applies to service contracts and Collective Bargaining Agreements could apply to DBA, DBRA, SCA or even manufacturing contracts issued by the government and also commercial contracts for construction, services, and/or manufacturing. The wage determination and/or collective bargaining agreements set parameters pertinent to prevailing wages, such as, but not limited to, minimum wage hourly rate, minimum vacation (if any), minimum holidays (if any), and/or minimum fringe benefit hourly rate. This last parameter is the most pertinent concerning the system 100. The system 100 may take the client data and analyze the data in conjunction with the minimum fringe benefit hourly rate. This analysis may provide, to a client, whether the client is or is not being compliant with the acts and/or agreements and what may be done to become compliant or save money with a more efficient management of payments. It is noted that compliance with the act and/or agreements requires an employer to provide “at least” the minimum fringe benefit hourly rate. Depending on what the goals of the client are, a plan of action for compliancy or efficiency may vary. The system may account for various types of fringe benefits including, but not limited to, medical, dental, vision, life, disability, accident, sickness, retirement plans, savings and thrift plans, severance pay, sick leave, civic and personal leave, and cost of apprenticeship or other type programs. The system 100 may further keep track of whether a client provides fringe benefits in the form of “cash in lieu of”, a company-sponsored benefit program/plan, and/or a combination of both.

The system 100 may be programmed to separate hours worked by an employee that are and are not eligible for fringe benefits. Eligible hours in one embodiment may include all hours paid up to 40 in a work week to include vacation hours, holiday hours, sick leave hours, and other paid leave hours. In this method, ineligible hours may include overtime hours, any hours in excess of 40 in a work week. In a second embodiment, eligible hours may include only hours worked, including overtime hours but excluding paid leave hours such as, but not limited to, vacation, holiday, sick leave, jury duty, and bereavement. In a third embodiment, eligible hours may in include both all hours worked and paid. The method for calculating the eligible fringe benefit hours is specified in the applicable wage determination and/or collective bargaining agreement which governs the employee's work.

FIG. 2 depicts a flow chart depicting the method of establishing and assuring compliance with fringe benefits for contracts subject to Davis-Bacon Act, Davis-Bacon Related Acts, Service Contract Act, and Collective Bargaining Agreements in accordance with one embodiment. To better follow the method and describe the process of database 180 integration this disclosure will follow an account from the point of client's need 248 and the client's service selection 202, 204, 206, 208, 210 agreement, onboarding employees to servicing and the maintenance of the account.

Once the correct services have been settled upon for a specific client, the system may receive, from a census 200, the client data pertinent to the client. The data received may include, but is not limited to, Social Security numbers, dates of birth, contract management information, selection of benefits information, hire dates, anniversary dates, wage determination information, labor categories, time with employer under contract information, time with employer under location information, and employer information. The client data may be updated with the use of a dashboard connected to the database 180 of data. This allows for the data to be updated in real-time. The database 180 may categorize the above information; the information may be categorized as employee information/data 218, contract information/data 220, company information/data 222, work location information/data 224, and/or wage determination repository information/data 252. The entire collection of this information may be referred to as queried information 214.

Data that is to be utilized may be retrieved from the database 180 and placed in a report. It is here that the data provided may be manipulated according to a service provided to a client. Within the database 180, queries 214 may extract data from employee information 218, contract information 220, company information 222, work location information 224, and/or wage determination (may include collective bargaining agreements) repository information 252 for one or more of the services provided to a client. Using one or more of the calculators 216, the queried data 214 is manipulated in order to be placed in reports such as, but not limited to, a compliance status/fringe benefit compliance report 226, a fringe benefit audit report 232, a fringe benefit forecast report 234, a fringe benefit administration report 228, a retirement plan deposit report 246, a conformance analysis report 238, an employee eligibility file for fringe benefit programs/plans 254, and a self-insured fringe benefit plan analysis report 256. Further queries 250 following the initial processing of the employee data 218, contract data 220, company data 222, work location data 224, and wage determination data 248 has been processed through the calculators create additional reports such as, but not limited to, productivity/loss reports 230, price adjustment reports 236, sick leave reports 240, vested vacation reports 244 and/or holiday reports 242. The data in the reports may be based on weekly, monthly, quarterly, and/or annual analyses. The reports provide analysis for fringe benefit compliance for contracts subject to Davis-Bacon Act, Davis-Bacon Related Acts, Service Contract Act, and Collective Bargaining Agreements. In another embodiment, the report may be in the form of a spreadsheet.

The reports may be generated with the assistance of fringe benefit compliance calculators 216 located within the database. These calculators 216 are programmed to take into consideration specific parameters relative to government acts mentioned in this disclosure. The calculators 216 may be programmed to complete a Service Contract Act fixed/individual cost calculation. This may be carried out using the fixed/individual cost calculation referenced in 29 C.F.R. §4.175(a) and (c) modeled after example 29 C.F.R. §4.175(a)(i-iv). The calculators 216 may be programmed to complete a Service Contract Act averaging cost calculation. This may be carried out using the Service Contract Act averaging cost calculation referenced in 29 C.F.R. §4.175(b). The calculators 216 may be programmed to complete a Collectively Bargained Fringe Benefit Calculation. This may be carried out using the collectively bargained fringe benefit calculation referenced in 29 C.F.R. §4.1(b). The calculators 216 may be programmed to complete a Davis Bacon Fringe Benefits Calculation. This may be carried out using the collectively bargained fringe benefit calculation referenced in 29 C.F.R. §5.2 through 29 C.F.R. §5.32.

In another embodiment, the database 180 may be a cloud database. The computing system 100 may be connected to the database 180 through a wired or wireless communication network (Internet) and may have the ability to send pertinent data to the database 180. For example, the system may utilize the program Microsoft® (a registered trademark of Microsoft, Inc.) SharePoint® (a registered trademark of Microsoft, Inc.).

The system and information gathering/manipulation may be divided into two subsystems. The first subsystem is the “Records and Management System”, wherein data is received, stored, and manipulated by services offered. The second subsystem is the “Business Intelligence System”, wherein the manipulated data is analyzed and compared to parameters related to boundaries of industry legalities. The above subsystems may both be implemented within the computing system 100.

Client needs 248 are identified in order to be able to understand what type of service(s) need to be provided to a client. These services include employee fringe benefit programs/management information system (MIS) services 208, fringe benefit trust and/or escrow account administration services 204, consulting services 206, auditing services 202, and educational services 210, all of which are explained in more detail below.

The following reports may be generated by utilizing the calculators 216 found in the database 180.

In one embodiment, a compliance status/fringe benefit compliance report 226 may be generated by the database 180. Applicable regulations pertinent to a compliance status/fringe benefit compliance report 226 include 29 CFR sections 4.163, 4.170-4.177, and 29 CFR sections 5.5, 5.23-5.32. For monthly reports, calculations may include: employee's total hours worked and paid 306 in each pay period during the month multiplied by an employee's fringe benefit hourly rate 308 minus the dollar value of sick leave 312 taken by the employee during the month minus benefits 314 paid by employer during the month minus any “cash in-lieu-of” benefits 316 paid to the employee equals the monthly balance, which may reflect an underpayment (which means the employer owes the employee more fringe benefits) or an overpayment (which means the employer paid the employee more than required by the applicable wage determination). The same steps may be used to calculate quarterly and annual reports.

A sample of the calculation method for fixed/individual fringe benefit requirements is shown below:

| Hours | | Fringe | Employer | |
|---|---|---|---|---|
| Worked | Hours × $3.50 | Requirement | Expense | Difference |
| 42 | 40 × $3.50 | $140.00 | $117.00 | $23.00 |
| 38 | 38 × $3.50 | $133.00 | $108.00 | $25.00 |
| 40 | 40 × $3.50 | $140.00 | $115.00 | $25.00 |
| 8 | 8 × $3.50 | $28.00 | $00.00 | $28.00 |
| 20 | 20 × $3.50 | $70.00 | $25.00 | $45.00 |

If the Employer Contribution is LESS than the H&W Requirement, employee is paid out. If the Employer Contribution is GREATER than the H&W Requirement, employer incurs no additional cost.

A sample of the calculation method for averaging fringe benefit requirement is shown below:

| | Hours | Employer |
|---|---|---|
| Employees | Worked | Paid Benefits |
| #1 | 42 | $117.00 |
| #2 | 38 | $108.00 |
| #3 | 40 | $115.00 |
| #4 | 8 | $00.00 |
| #5 | 20 | $25.00 |
| | 148 | $365.00 |

$365.00 in employer paid benefits divided by 148 hours employees collectively worked during the covered period on the contract is equal to $2.47/hour. The result is an average hourly fringe compensation rate for the group of $2.47/hour. The hourly fringe requirement in the applicable wage determination is $3.50. Subtracting the actual average hourly rate of $2.47 from the $3.50 fringe requirement calculates the fringe shortfall, which is $1.03. Therefore, each employee working on the contract during the covered period must receive the following in cash payment:

| Employees | Hours | | Total Shortfall | | Total |
|---|---|---|---|---|---|
| #1 | 42 | × | 1.03 | = | $43.26 |
| #2 | 38 | × | 1.03 | = | $39.14 |
| #3 | 40 | × | 1.03 | = | $41.20 |
| #4 | 8 | × | 1.03 | = | $8.24 |
| #5 | 20 | × | 1.03 | = | $20.60 |
| | 148 | | | | $152.44 |

The $365.00 in total employer paid benefits for the group of employees plus the $152.44 in total shortfall for the group equals $517.44. The $517.44 in combined employer paid benefits and shortfall divided by the 148 hours worked in the covered period equals a total of $3.50/hour, which is the fringe requirement for the contract in this scenario.

In another embodiment, a fringe benefit administration report 228 may be generated by the database 180. Applicable regulations pertinent to a fringe benefit administration report 228 include 29 CFR sections 4.163, 4.170-4.177, and 29 CFR sections 5.5 and 5.23-5.32. The report may include the cost of each bona fide fringe benefit offered by the employer and selected by the employee. The cost may usually be reflected in monthly premiums for insurance plans, as well as the cost of other types of allowed programs such as apprenticeships. The addition of all the premiums/costs results in the amount paid by an employer toward employee fringe benefits during a given month. That amount is reflected in the benefits paid section 314.

The total fringe benefit costs paid by employer may be subtracted from the total fringe benefit requirement 310, as well as the sick leave costs 312 and any “cash in-lieu-of” payments 316 to an employee for the month's total fringe benefit costs found in the balance section 318. Positive balances in the balance section 318 reflect an underpayment of fringe benefits by the employer on behalf of the employee. The delta is owed to the employee and can be discharged either by payment in cash to the employee or payment into another bona fide fringe benefit plan/program on behalf of the employee. Negative balances in the balance section 318 reflect overpayment of fringe benefits by the employer on behalf of the employee. No additional fringe benefits are owed the employee.

In yet another embodiment, a fringe benefit audit report 232 may be generated by the database 180. Applicable regulations pertinent to a fringe benefit audit report 232 include 29 CFR sections 4.163, 4.170-4.177, and 29 CFR sections 5.5 and 5.23-5.32. The calculations for Fringe Benefit Audit Reports 232 may be the same as those for Compliance Status/Fringe Benefit Compliance Reports 226. The primary difference between the reports for audit reports is that the data is retroactive; for compliance reports, the data is from the current or immediate past month.

In yet another embodiment, a fringe benefit forecast report 234 may be generated by the database 180. This report is usually for, but not limited to, forecasting compliance for the next benefit plan year. One method for calculation may be carried out by taking the standard annual full-time equivalent (FTE) work hours (2080) and dividing the work hours by 12 months, which equals 173.33/hours per month. Recognizing that most employees do not work all the available work hours in a given month, and often take “leave without pay” for the missed hours, the contractor will often forecast the expected work hours at 160/month. Taking the forecasted 160 hours/month and the applicable fringe rate, for example $4.00/hour, the employer may prepare a basic fringe benefit plan that costs no more than $640.00/month. (i.e. 160 hours×$4.00/fringe hour=$640.00).

In the event the FTE works the standard 173.33/hours per month, the fringe benefit dollars earned in excess of $640.00 can be paid as either “cash in-lieu-of” or used toward another bona fide fringe benefit plan (i.e. retirement plans).

In yet another embodiment, a conformance analysis report 238 may be generated by the database 180. Applicable regulations pertinent to a conformance analysis report 238 include 29 CFR section 4.6 (b)(2), which provides the details for contracts subject to the Service Contract Act of 1965.

A conformance request is the first step in the creation of a conformance analysis report. When preparing a bid, a contractor may identify the need for a conformed occupation(s) and may propose a rate(s). After a contract is awarded, the contractor may prepare a written report listing, in order, proposed classification title(s), a Federal grade equivalency (FGE) for each proposed classification(s), job description(s), and rationale for proposed wage rate(s), including information regarding the agreement or disagreement of the authorized representative of the employees involved, or where there is no authorized representative, the employees themselves. This report should may be submitted to the contracting officer no later than 30 days after such unlisted class(es) of employees perform any contract work. The contracting officer may then reviews the proposed action and promptly submit a report of the action, together with the agency's recommendations and pertinent information, including the position of the contractor and the employees, to the Wage and Hour Division, Employment Standards Administration, U.S. Department of Labor, for review (according to section 4.6(b)(2) of Regulations 29 CFR Part 4). Within 30 days of receipt, the Wage and Hour Division may approve, modify, or disapprove of the action via transmittal to the agency contracting officer, or may notify the contracting officer that additional time is required to process the request. The contracting officer may then transmit the Wage and Hour decision to the contractor. The contractor may inform the affected employees.

Information required by the Regulations must be submitted on Standard Form (SF) 1444 or bond paper. When preparing a conformance request, the “Service Contract Act Directory of Occupations” (the Directory) should be used to compare job definitions to insure that duties requested are not performed by a classification already listed in the wage determination. It is not the job title, but the required tasks that determine whether a class is included in an established wage determination. Conformances may not be used to artificially split, combine, or subdivide classifications listed in the wage determination.

Steps for completing the Standard Form (SF) 1444 include:
writing a detailed job description
identifying the most closely related wage determination (WD) classification
finding the Federal Grade Equivalents (FGE) for both the position being conformed and the most closely related WD classification
calculating a percentage differentials in wages between the two FGEs—(a) the classification to be conformed, and (b) the most closely related WD classification; and
describing the above process in an attachment to the SF 1444.

For subsequent years on a contract, an employer may use a process known as “indexing” to determine any wage and fringe benefit increases owed to the employee. Indexing is based on the average percentage increase between the rates for all occupational classes to be used in the new contract year and the corresponding rates for those same occupational classes in the previous contract year. An example is shown below:

| | WD Rev 22 | WD Rev 23 | % |
|---|---|---|---|
| Secretary I | $10.00 | $10.80 | 8 |
| Accounting Clerk | $10.50 | $10.71 | 2 |
| | | | 10 |

Previously Conformed Class: Administrative Assistant at $12.50×5%=New Indexed Rate is $13.13/hour.

29 CFR 5.5 (a) (1)(ii) may provide the conformance process details for contracts subject to the Davis-Bacon Act.

In yet another embodiment, a retirement plan deposit report 246 may be generated by the database 180. The retirement plan deposit report 246 may reflect the amount of fringe benefit dollars to be deposited into a bona fide retirement plan for each employee identified on a report. The deposits may be made monthly or quarterly. The calculation may be based on (1) a fixed amount designated for deposit during each covered period for the employee or (2) the calculation may reflect the delta amount during a covered period which is the amount of required fringe benefit dollars owed to an employee after the cost of all other bona fide fringe benefit plans/programs have been paid by the employer. Other calculation methods may be used based on the requirements of the applicable wage determination and/or collective bargaining agreement.

In yet another embodiment, an employee eligibility file report 246 for programs/plans may be generated by the database 180. For clients who select a Fringe Benefit Program/Management Information System (MIS) service, an eligibility file report 246 may be required for communication with the carriers/providers for transmitting information related to the employee's selected benefit program/plans. The report may include, but is not limited to, an employee name, employee dependents, social security numbers for both employee and dependents, dates of birth for employee and dependents, benefit selections for employee and dependents, a pay rate of the employee, a beneficiary designation, employee and dependent contact information, etc.

In yet another embodiment, a self-insured fringe benefit analysis report 256 for programs/plans may be generated by the database 180. 29 CFR 5.28 may provide the requirements for self-funded fringe benefit programs/plans for contracts subject to the Davis-Bacon Act. 29 CFR 4.171 may provide the requirements for self-funded fringe benefit programs/plans for contracts subject to the Service Contract Act. This report may depict the monthly, quarterly and/or yearly analysis of the funding of self-insured plans. The intent is to ensure that an employee may receive the minimum fringe benefit dollar value of the bona fide programs/plans selected and that the employer does not receive, even inadvertently, a benefit (i.e., lower estimated premiums in follow-on years of the program/plan due to low utilization of all employees in the program/plan including those not entitled to minimum fringe benefits as required by wage determinations (WDs)/collective bargaining agreements (CBA).

One method of calculation may include analyzing prior month's claims activity for all participants in a program/plan and separating out the claims of those employees with minimum fringe benefit requirements under a WD and/or CBA. Comparing the prevailing wage employees' claims against the current estimated annual liability limit of the employer for the prevailing wage employees' coverage and the current month's maximum payment may ensure that the prevailing wage employee may be receiving the value of the intended benefit.

The following reports may be generated by utilizing the calculators 216, as well as further queried information/data after calculations 250 found in the database 180.

In one embodiment, a productivity/loss report 230 may be generated by the database 180. This report may depict how much an employer either underpaid or overpaid in fringe benefit costs for a given month, quarter, and/or year. The calculation includes, but is not limited to, the total fringe requirement for the covered period minus the cost of all bona fide fringe benefit programs/plans (i.e. insurance plans, sick leave, vacation in excess of the prevailing wage minimum requirement, holiday in excess of the prevailing wage minimum requirement, etc.). A positive total, referenced at times as a shortfall/underpayment, may reflect how much the employer still owes the employee to meet fringe benefit compliance minimums. A negative total, referenced at times as overpayment, may reflect how much an employer overpaid in fringe benefits on behalf of the employee. Using this report, the employer may better manage the company's fringe benefit compensation plans in the future.

In another embodiment, a price adjustment report 236 may be generated by the database 180. Applicable regulations pertinent to a price adjustment report 236 include Federal Acquisition Regulations (FAR) sections 52.222-43 and 52.222-44.

The following is an example of Minimum Wage Rate Increase. The prior year wage determination required a minimum wage rate of $10.50 per hour. The new wage determination increases the minimum rate to $11.75 per hour. The allowable price adjustment is $0.40 per hour:

| | |
|---|---|
| Previous WD hourly rate: | $10.50/hr |
| New WD hourly rate: | $11.75/hr |
| Adjustment: | $1.25/hr |

The following is an example of Minimum Fringe Benefit Rate Increase. The prior year wage determination required a minimum wage rate of $3.16 per hour. The new wage determination increases the minimum rate to $3.24 per hour. The allowable price adjustment is $0.08 per hour:

| | |
|---|---|
| Previous WD fringe rate: | $3.16/hr |
| New WD fringe rate: | $3.24/hr |
| Adjustment: | $.08/hr |

Contractors may be allowed to also recover the cost of payroll taxes associated with the wage and/or fringe increases (i.e., Social Security taxes, Medicare taxes, and Workers' Compensation insurance.).

In yet another embodiment, a sick leave report 240 may be generated by the database 180. The statutory regulations for the Davis-Bacon Act and the Service Contract Act do not require minimum paid sick leave. Unless sick leave pay is specifically required in the applicable wage determination/collective bargaining agreement (if an employer offers paid sick leave), then it may, in some cases, be chargeable against the fringe benefit requirement. It may be considered a type of self-funded plan. If so, 29 CFR 5.28 may provide the requirements for self-funded fringe benefit programs/plans for contracts subject to the Davis-Bacon Act; 29 CFR 4.171 may provide the requirements for self-funded fringe benefit programs/plans for contracts subject to the Service Contract Act. The determination for fringe dollar value of sick leave may be calculated by multiplying an employee's hourly pay rate by the number of sick leave hours taken.

In yet another embodiment, a vested vacation report 244 may be generated by the database 180. The Davis-Bacon Act's (DBA) statutory regulations do not require minimum vacation fringe benefits. DBA wage determinations (WD)/collective bargaining agreements (CBA) applicable to a contract may reflect the minimum vacation requirements, if any, for the affected labor categories. If the DBA WD/CBA is silent with regard to minimum vacation requirements and if an employer still elects to provide paid vacation hours as a fringe benefit, the compliance regulations may be found in 29 CFR 5.28. The employer may charge the dollar value of the vacation pay against the minimum fringe benefit requirement owed the employee. The calculation is the base hourly wage rate multiplied by the number of vacation hours paid to the employee.

The Service Contract Act's (SCA) statutory regulations do require minimum vacation fringe benefits to be paid separate and apart from an employee's regular wages and health and welfare fringe benefits. The general guidelines are set forth in 29 CFR 4.173; the specific guidelines are set forth in the applicable WD and/or CBA in a contract.

If an employer provides more vacation leave in a given year than required by the applicable WD and/or CBA, the employer may charge the dollar value of that additional paid vacation leave against the minimum health & welfare fringe benefit requirement. The dollar value of the vacation in excess of the requirement may be calculated as an employee's hourly pay rate at the time vacation hours are taken multiplied by the number of vacation hours taken.

In yet another embodiment, a holiday report 242 may be generated by the database 180. The Davis-Bacon Act's (DBA) statutory regulations do not require minimum holiday fringe benefits. DBA wage determinations (WD)/collective bargaining agreements (CBA) applicable to a contract may reflect the minimum holiday requirements, if any, for the affected labor categories. If the DBA WD/CBA is silent with regard to minimum holiday requirements and if an employer still elects to provide paid holiday hours as a fringe benefit, the compliance regulations may be found in 29 CFR 5.28. An employer may charge the dollar value of the holiday pay against the minimum fringe benefit requirement owed the employee. The calculation is the base hourly wage rate multiplied by the number of holiday hours paid to the employee.

The Service Contract Act's (SCA) statutory regulations do require minimum holiday fringe benefits to be paid separate and apart from an employee's regular wages and health and welfare fringe benefits. The general guidelines are set forth in 29 CFR 4.174; the specific guidelines are set forth in the applicable WD and/or CBA in the contract.

If an employer provides more holiday leave in a given year than required by the applicable WD and/or CBA, the employer may charge the dollar value of that additional paid holiday leave against the minimum health and welfare fringe benefit requirement. The dollar value of the holiday in excess of the requirement may be calculated as an employee's hourly pay rate at the time holiday hours are taken multiplied by the number of holiday hours taken.

I. Records and Management System

The records and management system may be identified as the part of the database that may store client data and carries out services relative to a client's needs 248.

A. Employee Fringe Benefits Programs/Management Information System (MIS) Service

One service provided by the computing system 100 is the employee fringe benefit programs/management information system (MIS) service 208. This service may provide a selection of fringe benefit programs/plans for the employee's election and/or a report concerning fringe benefit information based off of the employee data supplied to the computing system 100. When an employer requests an employee fringe benefit programs/management information system (MIS) service 208, the database 180 will gather the proper employee data and supply a fringe benefits compliance report 226 and a fringe benefits administration report 228. The report may be utilized in the fringe benefit programs/management information systems (MIS) service 208 in order to manage the client data in the report.

The fringe benefit programs/management information systems (MIS) service 208 requires data such as benefit program/plan elections, wage determination/collective bargaining agreement data and an employee's attendance trends on working his/her full assigned hours during any given week. This data may populate the formulas that will be utilized for the fringe benefit trust and/or escrow account services calculations. This data may populate the formulas that will be utilized for price adjustment reports 236 when increases in wages and/or fringe benefits is allowed by law or conformance analysis reports when required by law 238. The reports may be supplied and further utilized in a fringe benefit trust and/or escrow account administration service 204.

If an employer has only chosen fringe benefit programs/management information systems (MIS) services 208, the disclosed system may utilize the employee data (in particular, but not limited to, hours paid/worked, fringe benefit hourly rates, benefit program(s)/plan(s) costs, and the anniversary date) to assist the employer with Department of Labor prevailing wage compliance and with calculating and/or managing the monthly fringe benefit trust and/or escrow account deposit for disbursement from the account of fringe funds to cover the cost of fringe benefit programs/plans. The employees may be provided fringe benefits either through company-sponsored trusts/plans/programs or as “cash in lieu of” according to that year's fringe benefit minimum hourly rate in the applicable wage determination/collective bargaining agreement. When the employer elects to provide fringe benefits through company-sponsored trust/plan/program, an employee eligibility file 254 may be required for transmitting data to the trustee/carrier/provider. The fringe benefit minimum requirement for the employee is calculated using the total number of hours worked or paid to the employee depending on the requirements of the applicable wage determination/collective bargaining agreement.

The minimum hourly fringe benefit rate is determined by the wage determinations issued by Department of Labor or a collective bargaining agreement and may be automatically updated in the system through a windows task function or manually retrieved through a “get” function code. Client employers may have access to the fringe benefit minimum hourly rates and the employee's calculated minimum requirement for the covered period through the disclosed dashboards. The disclosed dashboard may include tools for account maintenance, data retrieval, and automated reminders through Outlook® and Sharepoint® web ports. The dashboards may also be operating on real-time reporting. Immediately after any updates of data in the database 180 are carried out by a client, a client's employee or other staff/team member(s), the updated data may be immediately accessed for reports, graphs, animation, and other creative but relevant means.

B. Fringe Benefit Trust and/or Escrow Account Administration Services

Fringe benefit trust and/or escrow account administration services may require fringe benefit compliance reports 226, fringe benefits administration reports 228, retirement plan deposit reports 246, sick leave reports 240, fringe benefit audit reports 232, and/or other available reports from the database 180. Using information from these reports disbursements are made to appropriate bona fide benefit trust/plan/program.

Within the dashboard, report generation may be completed; reports may be fully customized to the client's needs. In the case of fringe benefit trust and/or escrow account services, the current account standings of employees may be accessible to both the employer and the employee. Further, the current and ongoing compliance with regard to prevailing wage requirements may be accessible to employers.

C. Consulting Services

The system 100 may function as a consulting service for a client. The consulting tasks that the system 100 may carry out comprise, but are not limited to, contracts management and/or administration, budget forecasting, pricing strategies, lost productivity analysis, prevailing wage conformance and price adjustment processes, and methodology to follow for state and/or U.S. Department of Labor (DoL) compliance up to and including formal agency audits, and software specific development that caters to a customer's need to integrate their actual business and worksite/lab environments and incorporating it into various standards of management with a heavy use of metrics. These tasks may be carried out using information found in the chart found in FIG. 2, in particular but not limited to, the compliance status/fringe benefit compliance report 226 and all other related reports 226-246 supplied by the database 180.

D. Auditing Services

The method further includes an auditing service 202 based on the client information is retroactively provided. Analyses relative to oversight of the client information is provided. Periodical comparison of analyses of the client information with refined parameters based on industry legalities is further included. In addition to historical compliance analyses, other types of audits available through use of the database 180 would include but are not limited to vested vacation audits and productivity/loss audits. Since the presently disclosed system gathers and stores benefit and payroll data in relation to clients, a client may tie in ancillary auditing services such as vested vacation compliance audits. Vested vacation is an annual bank of hours, tied into the database 180 through payroll tables.

Prevailing wage compliance issues related particularly to minimum vested vacation requirements requires the system to analyze individual employee payroll hours to see if prevailing wage standards had been considered with regard to the schedule for vacation time vested with each employee, retroactively or currently, and how this data can be a tool for future contract pricing consideration. Future government contracts may be renewed or inherited with incumbent employees close to their annual anniversary date, which means the minimum prevailing wage vacation requirement owed to the employee will be due immediately after the contract start date or soon thereafter.

An employer may not have budgeted for this expense and/or the expense that comes from the penalty of inadvertently not giving employees the required vested vacation owed on the employee's annual anniversary date. The vested vacation audit analysis is designed and considered within proprietary formulas within the database 180 and reported through customized reports.

Taking date of hire and anniversary date into account, a client may look at other auditing factors that aid in providing consulting services (i.e., unit pricing and budget forecasting) for clients use during the proposal phase of a contract pursuit with the government.

Another useful process associated with the system includes the generation and use of productivity/loss reports 230. For government contractors, the government often only pays direct labor, fringe benefits (i.e., health and welfare, vacation, holiday, sick leave, etc.), overhead, general and administrative, and profit margins on the actual billed hours to a contract. When the billable rate is dependent upon the actual hours physically worked by each contract employee on the government contract, then any hours not worked in any given work week (usually known as “leave without pay”) by the employee, those missed hours cannot be billed to the government. As a result, the contractor loses the overhead, general & administrative, fringe benefit, and profit dollars built into the fully burdened pricing rate for each missed hour. This is usually a “permanent” loss of revenue to the employer.

The system's productivity/loss reports 230 demonstrate to the employer all budgeted hours of fringe benefit dollars missed due to “leave without pay” issues. Using the total missed hours on the report, the employer may incorporate the company's overhead rate, general and administrative rate, remaining fringe benefit rate, and profit rate in order to calculate the total lost revenue to the company for each hour allotted on the contract that is not worked, and therefore, not billed to the government. The employer may sustain an even greater loss if the employee doesn't work enough hours in order to earn enough fringe benefit dollars to cover the entire cost of the benefit programs/plans for a given month.

E. Educational Services

The system may offer educational services 210 pertinent to the compliance of Department of Labor standards. This service may be offered mainly through video modules but may also be offered in person at seminars or even on-site at client offices. The handling of the videos through the database 180 will also be a feature available to clients in a “frequently asked questions” format or in “train the staff” capabilities and can also be added to any suite of services or simply as a standalone service. The modules may exist on the database 180 as a clipped function.

The pertinent issues focused on in the educational services 210 include how a client may comply with the Department of Labor standards. Using the educational services 210, a user may learn how to comply with Department of Labor standards. To further help with the education process, a user may access web accessible videos/printable material 212 from the database 180. The web accessible videos/printable material 212 may be accessed through a dashboard connected to the database 180.

II. Business Intelligence System

The Business Intelligence System may be identified as the part of the database 180 that comprises analyses relative to services rendered to client data as well as comparisons of analyses of client data to refined parameters in order to keep the client within boundaries of industry legalities. The database 180 may generate customized client reports (such as the reports found in FIG. 2) that analyze the client data and contribute to carrying out the services rendered in the records and management system of the database 180.

FIG. 3A depicts a screen image of a monthly fringe benefit compliance report in accordance with one embodiment. This chart may depict how a regular monthly compliance report or an audit report may be displayed in the system 100. The total fringe hours section 306 may display employees' total amount of hours worked and may be calculated for each employee by adding the pay period hours (in this chart, 80 hour and 80 hour columns 302, 304). A reported pay period could be weekly, bi-weekly, or semi-monthly. The fringe rate section 308 may be found next to the total fringe hours section 306. The rates found in this section may fluctuate and therefore may automatically update if the fringe rate changes. Multiplying the amounts in the fringe hours section 306 and the amounts in the fringe rate section 308 for each employee will create employees' fringe benefit totals found in the fringe requirement section 310, which is the required benefit amount that should be paid for each employee by an employer.

The column adjacent to the fringe requirement section 310 is the sick leave fringe section 312. This section displays the fringe benefit dollars an employee uses when sick leave hours are taken; this amount is subtracted from the fringe benefits found in the fringe requirement section 310. The benefits paid total section 314 is found next to the sick leave fringe section 312, which includes the actual fringe benefits paid into a trust/plan/program by the employer on behalf of the employees for that month. The actual fringe benefits compensation is found by adding the fringe benefits in the sick leave fringe section 312 with the benefits paid section 314 and the cash benefits section 316. The differences between these totals and the fringe requirements 310 is the amount of fringe benefit compensation that an employer is under or overpaying, in a given month, which are the totals found in the balance section 318.

FIG. 3B depicts a screen image of a chart depicting “cash in lieu of” fringe benefits in accordance with one embodiment. The “cash in lieu of” is the amount of cash paid to employees by an employer for benefits. The “cash in lieu of” is found in the cash total section 316. The cash is tracked weekly, biweekly or semi-monthly depending on the employer's selected payroll cycle; the cash amounts may be found in the first pay period cash section 319 and the second pay period cash section 320. In the chart, the example employer did not pay out any benefits as “cash in-lieu-of” on the contract with an averaging method for fringe benefit calculations, however, did provide “cash in-lieu-of” benefits to some employees on the contract with a fixed/individual method for fringe benefit calculations.

In another embodiment, the cash amounts may be recorded during a time period other than weekly, biweekly or semi-monthly, such as but not limited to, monthly, quarterly, and yearly (depending on what exists in the chart found in FIG. 3A (monthly), FIG. 8 (quarterly), and FIG. 9 (annually).).

FIG. 4 depicts a screen image of a chart depicting sick leave paid in accordance with one embodiment. The employee hourly pay rate may be found in the employee pay rate section 322. These pay rates may be multiplied by the number of sick leave hours employees take, found in the sick pay period section 324. The multiplied totals may be found in the sick leave fringe section 312.

FIG. 5 depicts a screen image of a chart depicting bona fide fringe benefit plans in accordance with one embodiment. This chart may display, for multiple employees, insurance premiums and other types of bona fide fringe benefit trusts/plans/programs. The premium section 325 may display individual employees' premium. The ER Paid section 326 may display how much of the monthly premiums that the employer pays toward the individual employees' selected benefits. If the employee pays any portion of the premiums there will be an additional section to reflect the amount of the employee contributes towards his/her benefit plans/programs. The combination of the employer's contribution and employee's contribution should total the premium cost for the covered period.

FIG. 6 depicts a screen image of chart depicting total benefits credit toward fringe benefits in accordance with one embodiment. This chart may display and compare employees' total benefits with a retroactive premium as well as employees' benefits paid by the employer. The retrospective premium section 328 may display, for each employee, a premium based on retro invoicing by the benefit carrier/provider. These premiums may be the same as, or different than, the benefits found in the benefits paid total section 314. Due to retroactive or out-of-cycle billing by benefit carrier/provide (i.e. for addition of new hires or deletion of terminated employees), the monthly invoice may be greater or less than the usual billing amount. For self-insured fringe benefit plans, the database 180 generates a report depicting compliance with the acts to ensure that employees receive the full actuarially estimated fringe benefit for that plan. The report may include, but is not limited to, claim activity, current month maximum payment, and/or shortfall or overage paid by employer on a monthly, quarterly, and/or annual basis.

FIG. 7 depicts a screen image of a chart depicting a portion of a quarterly fringe benefit compliance report with both averaging and individual calculation methods in accordance with one embodiment. The resulting report could also depict quarterly balances for employees subject to a collective bargaining agreement. This chart may display monthly trust/escrow account balances found in the October, November, and December balance sections 330A, 330B, 330C. The quarter total section 332 may display the employee quarterly total (three months) trust/escrow account balances; these balances are calculated by adding the trust balance totals in the three monthly balances section 330. The method by which the trust/escrow account balance is calculated is based on the terms of the wage determination and/or collective bargaining agreement applicable to the contract on which the employee works. The possible methods for calculating compliance of the minimum fringe benefits requirements in the acts are determined on either a fixed/individual employee basis or an averaging basis of all the employees working on the contract during the covered period.

FIG. 8 depicts a screen image of a chart depicting a quarterly fringe benefit compliance report using the averaging calculation method in accordance with one embodiment. This chart may display monthly trust/escrow account balances found in the monthly balances sections 330 as well as an average shortfall of payment hourly 352 and an average shortfall of payment quarterly 334 per employee. The system 100 may retroactively calculate the average amount of shortfall for all employees per hour, which may be found in the hourly fringe shortfall section 352. The average shortfall may then be multiplied by the total number of hours employees have worked in a quarter in order to get employee quarterly shortfalls, which are found in the quarter fringe shortfall section 334. The employee quarterly shortfall totals may be added together to acquire an overall quarterly shortfall, which is the same amount as the overall quarter total found in the quarter total section's subtotal box for the averaging calculation group of employees 332. For contracts utilizing the averaging calculation method for fringe benefits, the totals in the October, November, and December balance sections 330A, 330B, and 330C are not applicable. This calculation method requires compliance with acts to be determined on a multiple employee averaging basis.

For contracts utilizing the fixed/individual calculation method for fringe benefits, the totals in the October, November, and December balance sections 330A, 330B, 330C depict the monthly over or under payment by the employer of the fringe benefit requirement on a monthly basis which in some cases can be averaged over a quarter. The quarter total in section 332 reflects the quarterly over or under payment. This calculation method requires compliance with acts to be determined on a fixed/individual employee basis.

FIG. 9 depicts a screen image of a chart depicting an annual fringe benefit compliance report with delta calculations in accordance with one embodiment. This chart displays a number of sections pertinent to a fringe benefit compliance report and/or an audit report. The chart comprises sections of information pertinent to employees such as, but not limited to, a yearly hours section 336, yearly fringe shortfall section 338, yearly sick leave section 340, yearly benefits section 342, yearly cash paid section 344, yearly trust/escrow account balances section for individual basis calculations 346, yearly trust/escrow for both averaging and individual calculation totals section 348, and yearly difference total section for audits 350.

The yearly hours section 336 displays the number of hours employees have worked in a specific year. The yearly fringe shortfall section 338 displays the additional fringe benefits to be paid and/or should have been paid to employees and the actual fringe benefits employees received for a contract requiring an averaging calculation of fringe benefits for the covered employees during a specific year. The yearly sick leave section 340 displays the fringe dollar value of sick leave hours employees have utilized in a specific year. The yearly benefits section 342 displays the dollar amount paid by the employer into bona fide fringe benefit trusts/plans/programs on behalf of covered employees during a specific year. The yearly cash paid section 344 displays the amount of cash employees have been paid by employers to cover part or all of the employees' fringe benefits. The yearly trust/escrow account balances section 346 displays the difference in the fringe benefits an employee has received and the required fringe benefits an employee should receive on contracts requiring a fixed/individual calculation of fringe benefits for covered employees during a specific year. For contracts requiring an averaging calculation of fringe benefits, this section is not applicable. The yearly totals section 348 displays the shortfall, if any, owed the employees on a contract requiring averaging calculations and the over or underpayment for the employees on a contract requiring fixed/individual calculation method. For retrospective audits, the yearly difference total section 350 displays the audit results illustrating the difference in the calculated fringe benefits according to the system 100 providing the under or overage of fringe benefits paid by the employer on behalf of the employee in a specific year. This difference may tell an employer how much was overpaid in fringe benefits in a specific year which will assist in structuring the following year's fringe benefit compensation structure. This difference may also tell an employer how much was underpaid in fringe benefits, which means an additional payment is owed the affected employee.

FIG. 10 depicts a flowchart depicting the process of data collection and analysis in the system 100 in accordance with one embodiment. Pertinent client data may be received from clients, specifically government contractors and commercial entities, in the form of a census 200. This information may be taken and stored in the database under specific categories such as, but not limited to, employee information/data 218, contract information/data 220, company information/data 222, work location information/data 224, and wage determination repository information/data 252 (may include collective bargaining agreement (CBA) information/data when CBA is applicable to contract on which employee is working). The data may then be taken and put into a report formatted to correlate with a specific type of service to be rendered for a client.

Once the data is in a proper format, client data may be subject to one or more specific services rendered for a client. These services may include, but are not limited to, auditing services 202, fringe benefit trust and/or escrow account administration services 204, consulting services 206, and fringe benefit programs/management information systems services 208. These services may be carried out by the database with the help of calculators 216 programmed to comply with specific statutes found in 29 C.F.R. §5.23-5.32, 29 C.F.R. §5.5, and 29 C.F.R. §4.173-4.177.

Once the data is subject to one or more of the above services, further data may be added to the already existing data before a final analysis is provided. The analysis information gathered may also be found in the report at this point. The final analysis may be based on the refined parameters utilized by the calculators 216 in the database 180 and may show the status of a company in relation to a specific aspect of payment of fringe benefits (overpaying, underpaying, etc.).

Due to the availability of dashboards connected to the database for clients, analyses may be periodically compared in order to provide an up to date analysis for a client. For instance, if client data has changed, the client may update the data and may be provided with a new analysis based on the client data.

FIG. 11A depicts a first section of a flowchart depicting the interrelation of code representative of pertinent client data. The flowchart may depict various sets of data related to a specific employee. The data found in the Pay Period Type section 400 may contribute to the Pay section 408. The Contact Type section 402 may contribute to the Contact section 410. The Leave Type section 404 and Employee Type section 406 may contribute to the Leave section 412. The Pay section 408, Contact section 410, and Leave section 412 may all contribute to the Company section 414. The Company section 414 may contribute to the Payroll Data section 418, Contract section 420, Employee section 424, and Insurance section 428. The Wage Determination section 416 may contribute to the Contract section 420 and the Employee section 424. The Payroll Data section 418 may contribute to the Employee section 424. The Contract section 420 may contribute to the Employee Section 424. The Labor Category section 422 may contribute to the Employee section 424. The Employee section 424 may contribute to the Employee Insurance Elections section 426.

FIG. 11B depicts a second section of a flowchart depicting the interrelation of code representative of pertinent client data. The Employee Insurance Elections section 426 may contribute to the Insurance Plan section 430. The Insurance section 428 may contribute to the Insurance Plan section 430 and the Insurance Plan Type section 432. The Insurance Plan section 430 may contribute to the Insurance Enroll Type section 434.

For the purposes of this disclosure, “contribute” may refer to a section found in FIG. 11A or FIG. 11B being linked to and contributing information to another section found in FIG. 11A or FIG. 11B.

For the flowchart found in FIG. 11A and FIG. 11B, the code may be used that is representative of client data. Code may represent data such as, but not limited to, IDs, types of information, companies, beginning dates, end dates, pay dates, contacts, employee names, phone numbers, fax numbers, email addresses, descriptions, mailing addresses, signatories, fees, health and welfare hours, health and welfare (in cash), hours worked, holiday hours, vacation hours, sick hours, other hours, overtime hours, work locations, work states, sexual orientations, marital statuses, hire dates, dates of birth, seniority dates, premiums, Service Contract Act contributions, employer contributions, account numbers, eligibility policies, and insurance carriers.

For the purposes of this disclosure, any of the services provided may be offered either online or in person.

For the purposes of this disclosure, the terms “client” and “user” are synonymous.

For the purposes of this disclosure, the terms “client data”, “client information”, “data”, and “information” are synonymous.

For the purposes of this disclosure, the term “report” refers to a document, which, when in electronic form, may contain data that may be manipulated.

What is claimed is:

1. A method for establishing and assuring fringe benefit compliance for contracts subject to Davis-Bacon Act, Davis-Bacon Related Acts, Service Contract Act, and Collective Bargaining Agreements comprising:
receiving from a client, client data pertinent to the client by a computing system, wherein the computing system comprises a link to a database;
storing the client data in the database;
using a computing system to provide a report, wherein client data is entered into fields of the report;
providing at least one service, wherein the providing at least one service comprises manipulating client data in the report, further wherein the at least one service is selected from the group consisting of: an employee fringe benefits management information system program service based on the client data, a trust/escrow account service based on the client data, a consulting service based on the client data, and providing a retroactive auditing service based on the client data;
providing analyses relative to the at least one service rendered to the client data, wherein the at least one service provides refined parameters to stay within the boundaries of industry legalities; and
periodically comparing analyses of the client data.

2. The method of claim 1, wherein the client is a government contractor or commercial entity.

3. The method of claim 1, wherein the client data comprises employee personal information comprising Social Security numbers, dates of birth, contract administration information, selections of benefits, hire dates, anniversary dates, wage determination numbers, time with employers under contracts and locations, and information of employers.

4. The method of claim 1, wherein the database may be periodically updated using a dashboard, wherein the dashboard utilizes real-time reporting.

5. The method of claim 4, wherein the database is a cloud database.

6. The method of claim 1, wherein the trust/escrow account service is selected from the group consisting of: a shortfall management service, an employer credit management service, an account management for employees service, and a financial management service for the employees on behalf of the employers.

7. The method of claim 1, wherein the employee fringe benefits management information system program service comprises a health provider data management service and a trust/escrow account management service.

8. The method of claim 1, wherein the consulting service comprises education services for the clients.

9. The method of claim 8, wherein the education services may be accessed online or in person by the client.

10. A fringe benefit management information service system comprising:
a memory;
a database, wherein the database comprises a census populated by client data;
a display; and
a processor, wherein the processor is operably connected with the memory and the display, and the processor is configured to:
receive from a client, client data pertinent to the client by a computing system, wherein the computing system comprises a link to a database;
store the client data in the database;
use a computing system to provide a report, wherein client data is entered into fields of the report;
provide at least one service, wherein the at least one service provided comprises client data manipulation in the report, further wherein the at least one service is selected from the group consisting of: an employee fringe benefits management information system program service based on the client data, a trust/escrow account service based on the client data, a consulting service based on the client data, and providing a retroactive auditing service based on the client data;
provide analyses relative to the at least one service rendered to the client data, wherein the at least one service provides refined parameters to stay within the boundaries of industry legalities; and
periodically compare analyses of the client data.

11. The system of claim 10, wherein the client is a government contractor or commercial entity.

12. The system of claim 10, wherein the client data comprises employee personal information comprising Social Security numbers, dates of birth, contract administration information, selections of benefits information, hire dates, anniversary dates, wage determination numbers, time with employers under contracts and locations, and information of employers.

13. The system of claim 10, wherein the database may be periodically updated using a dashboard, wherein the dashboard utilizes real-time reporting.

14. The system of claim 13, wherein the database is a cloud database.

15. The system of claim 10, wherein the employee fringe benefits management information system program service comprises a health provider data management service and a trust management service.

16. The system of claim 10, wherein the trust/escrow account service is selected from the group consisting of: a shortfall management service, an employer credit management service, an account management for employees service, and a financial management service for the employees on behalf of the employers.

17. The system of claim 10, wherein the consulting service comprises education services for the clients.

18. The system of claim 17, wherein the education services may be accessed online or in person by the client.

19. A computer program product comprised of a non-transitory computer usable storage medium having computer readable program code embodied in the medium, the computer readable program code comprising:
computer readable program code that receives from a client, client data pertinent to the client by a computing system, wherein the computing system comprises a link to a database;
computer readable program code that stores the client data in the database;
computer readable program code that utilizes a computing system to provide a report, wherein client data is entered into fields of the report;
computer readable program code that provides at least one service, wherein the at least one service provided comprises client data manipulation in the report, further wherein the at least one service is selected from the group consisting of: an employee fringe benefits management information system program service based on the client data, a trust/escrow account service based on the client data, a consulting service based on the client data, and providing a retroactive auditing service based on the client data;
computer readable program code that provides analyses relative to the at least one service rendered to the client data, wherein the at least one service provides refined parameters to stay within the boundaries of industry legalities; and
computer readable program code that periodically compares analyses of the client data.

20. The computer program product of claim 19, wherein the client is a government contractor or commercial entity.

21. The computer program product of claim 19, wherein the client data comprises employee personal information comprising Social Security numbers, dates of birth, contract administration information, selections of benefits information, hire dates, anniversary dates, wage determination numbers, time with employers under contracts and locations, and information of employers.

22. The computer program product of claim 19, wherein the database may be periodically updated using a dashboard, wherein the dashboard utilizes real-time reporting.

23. The system of claim 22, wherein the database is a cloud database.

24. The system of claim 19, wherein the employee fringe benefits management information system program service comprises a health provider data management service and a trust management service.

25. The system of claim 19, wherein the trust/escrow account service is selected from the group consisting of: a shortfall management service, an employer credit management service, an account management for employees service, and a financial management service for the employees on behalf of the employers.

26. The system of claim 19, wherein the consulting service comprises education services for the clients.

27. The system of claim 26, wherein the education services may be accessed online or in person by the client.
